(19) United States
(12) Patent Application Publication
(10) Pub. No.: US 2025/0315598 A1
(43) Pub. Date: Oct. 9, 2025

(54) DIGITAL ASSISTANT RESPONSES USING APPLICATION INTERFACES

(71) Applicant: Apple Inc., Cupertino, CA (US)

(72) Inventors: Cameron BURGESS, San Francisco, CA (US); Ramon GILABERT LLOP, San Francisco, CA (US); Cas G. LEMMENS, San Francisco, CA (US); Raymond PAI, San Jose, CA (US); Giancarlo YERKES, San Francisco, CA (US); Jamie L. MYROLD, Chicago, IL (US)

(21) Appl. No.: 19/022,526

(22) Filed: Jan. 15, 2025

Related U.S. Application Data
(60) Provisional application No. 63/631,296, filed on Apr. 8, 2024.
(60) Provisional application No. 63/646,837, filed on May 13, 2024.
(60) Provisional application No. 63/657,740, filed on Jun. 7, 2024.

(51) Int. Cl. G06F 40/166; G06F 40/30; G06T 13/80

(52) U.S. Cl. CPC G06F 40/166; G06F 40/30; G06T 13/80

(57) ABSTRACT

An example process includes: receiving a first natural language input that corresponds to a request to perform a first task with a first application, where the first natural language input specifies an entity for the first task; and in response to receiving the first natural language input and after the entity is determined: in accordance with a determination that a set of criteria is satisfied, where the set of criteria includes a first criterion that is satisfied when a data type for the determined entity does not match a data type accepted by the first application: causing the data type for the determined entity to be modified to match the data type accepted by the first application to obtain a compatible data type for the determined entity; and initiating the first task based on the compatible data type for the determined entity.

### CROSS-REFERENCE TO RELATED APPLICATIONS

This application claims priority to U.S. Provisional Patent Application No. 63/631,296, entitled “DIGITAL ASSISTANT RESPONSES USING APPLICATION USER INTERFACES,” filed on Apr. 8, 2024, to U.S. Provisional Patent Application No. 63/646,837, entitled “DIGITAL ASSISTANT RESPONSES USING APPLICATION USER INTERFACES,” filed on May 13, 2024, and to U.S. Provisional Patent Application No. 63/657,740, entitled “DIGITAL ASSISTANT RESPONSES USING APPLICATION USER INTERFACES”, filed on Jun. 7, 2024. The entire contents of each of these applications are hereby incorporated by reference in their entireties for all purposes.

### FIELD

This relates generally to intelligent automated assistants and, more specifically, to integrating intelligent automated assistant functionality with the functionalities of other software applications.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

### SUMMARY

Example methods are disclosed herein. An example method includes, at an electronic device having one or more processors and memory: receiving a first natural language input that corresponds to a request to perform a first task with a first application, wherein the first natural language input specifies an entity for the first task; and in response to receiving the first natural language input and after the entity is determined: in accordance with a determination that a set of criteria is satisfied, wherein the set of criteria includes a first criterion that is satisfied when a data type for the determined entity does not match a data type accepted by the first application: causing the data type for the determined entity to be modified to match the data type accepted by the first application to obtain a compatible data type for the determined entity; and initiating the first task based on the compatible data type for the determined entity.

Example non-transitory computer-readable media are disclosed herein. An example non-transitory computer-readable storage medium stores one or more programs. The one or more programs comprise instructions, which when executed by one or more processors of an electronic device, cause the electronic device to: receive a first natural language input that corresponds to a request to perform a first task with a first application, wherein the first natural language input specifies an entity for the first task; and in response to receiving the first natural language input and after the entity is determined: in accordance with a determination that a set of criteria is satisfied, wherein the set of criteria includes a first criterion that is satisfied when a data type for the determined entity does not match a data type accepted by the first application: cause the data type for the determined entity to be modified to match the data type accepted by the first application to obtain a compatible data type for the determined entity; and initiate the first task based on the compatible data type for the determined entity.

Example electronic devices are disclosed herein. An example electronic device comprises one or more processors; a memory; and one or more programs, where the one or more programs are stored in the memory and configured to be executed by the one or more processors, the one or more programs including instructions for: receiving a first natural language input that corresponds to a request to perform a first task with a first application, wherein the first natural language input specifies an entity for the first task; and in response to receiving the first natural language input and after the entity is determined: in accordance with a determination that a set of criteria is satisfied, wherein the set of criteria includes a first criterion that is satisfied when a data type for the determined entity does not match a data type accepted by the first application: causing the data type for the determined entity to be modified to match the data type accepted by the first application to obtain a compatible data type for the determined entity; and initiating the first task based on the compatible data type for the determined entity.

An example electronic device comprises: means for receiving a first natural language input that corresponds to a request to perform a first task with a first application, wherein the first natural language input specifies an entity for the first task; and means, in response to receiving the first natural language input and after the entity is determined, for: in accordance with a determination that a set of criteria is satisfied, wherein the set of criteria includes a first criterion that is satisfied when a data type for the determined entity does not match a data type accepted by the first application: causing the data type for the determined entity to be modified to match the data type accepted by the first application to obtain a compatible data type for the determined entity; and initiating the first task based on the compatible data type for the determined entity.

Automatically modifying the data type for the determined entity to obtain a compatible data type if certain conditions are met expands the capabilities of a digital assistant. For example, obtaining the compatible data type can allow a digital assistant to satisfy requests that involve using data from a software application to perform a task using another software application. Accordingly, the number of different types of tasks a digital assistant can handle are increased, thereby increasing the flexibility and usefulness of the digital assistant. In this manner, the user-device interaction is made more efficient (e.g., by allowing a digital assistant to perform more types of tasks, by reducing the number of user inputs otherwise required to manually perform the tasks, and by preventing the digital assistant from returning responses indicative of errors), which additionally reduces power usage and improves battery life of the device by enabling the user to use the device more quickly and efficiently.

Example methods are disclosed herein. An example method includes, at an electronic device having one or more processors and memory: while displaying a user interface for an application, receiving a natural language input; and in response to receiving the natural language input: in accordance with a determination that a user intent corresponds to a predetermined intent associated with the application, wherein the user intent is determined based on the natural language input: initiating a first task based on the user intent, wherein initiating the first task includes initiating a search, and wherein initiating the first task includes modifying the user interface for the application, without displaying, outside of the user interface for the application, a graphical response that is based on the user intent.

Example non-transitory computer-readable media are disclosed herein. An example non-transitory computer-readable storage medium stores one or more programs. The one or more programs comprise instructions, which when executed by one or more processors of an electronic device, cause the electronic device to: while displaying a user interface for an application, receive a natural language input; and in response to receiving the natural language input: in accordance with a determination that a user intent corresponds to a predetermined intent associated with the application, wherein the user intent is determined based on the natural language input: initiate a first task based on the user intent, wherein initiating the first task includes initiating a search, and wherein initiating the first task includes modifying the user interface for the application, without displaying, outside of the user interface for the application, a graphical response that is based on the user intent.

Example electronic devices are disclosed herein. An example electronic device comprises one or more processors; a memory; and one or more programs, where the one or more programs are stored in the memory and configured to be executed by the one or more processors, the one or more programs including instructions for: while displaying a user interface for an application, receiving a natural language input; and in response to receiving the natural language input: in accordance with a determination that a user intent corresponds to a predetermined intent associated with the application, wherein the user intent is determined based on the natural language input: initiating a first task based on the user intent, wherein initiating the first task includes initiating a search, and wherein initiating the first task includes modifying the user interface for the application, without displaying, outside of the user interface for the application, a graphical response that is based on the user intent.

An example electronic device comprises: means, while displaying a user interface for an application, for receiving a natural language input; and means, in response to receiving the natural language input, for: in accordance with a determination that a user intent corresponds to a predetermined intent associated with the application, wherein the user intent is determined based on the natural language input: initiating a first task based on the user intent, wherein initiating the first task includes initiating a search, and wherein initiating the first task includes modifying the user interface for the application, without displaying, outside of the user interface for the application, a graphical response that is based on the user intent.

Automatically modifying the user interface for the application without displaying the graphical response outside of the user interface for the application allows a digital assistant to provide requested information efficiently and effectively without cluttering displayed content. Further, modifying the user interface for the application according to the techniques discussed herein allows the digital assistant to present and organize requested information in a manner that is informative and intuitive. In this manner, the user-device interaction is made more efficient (e.g., by reducing the number of user inputs required to cease display of unwanted information, by reducing the number of user inputs required to reorganize a user interface, by decluttering user interfaces, and by avoiding redundant display of information), which additionally reduces power usage and improves battery life of the device by enabling the user to use the device more quickly and efficiently.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4A is a block diagram of an exemplary multifunction device with a display and a touch-sensitive surface, according to various examples.

FIGS. 4B-4G illustrate the use of Application Programming Interfaces (APIs) to perform operations.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates an exemplary foundation system including a foundation model, according to various examples.

FIG. 9 illustrates a block diagram of a system for integrating digital assistant functionality with the functionalities of other software applications, according to various examples.

FIGS. 10A-10M illustrate various user interactions with a digital assistant that operates on a device, according to various examples.

FIGS. 11A-11I illustrate various user interactions with a digital assistant that operates on a device, according to various examples.

FIGS. 11J-11P illustrate user interfaces associated with insertion of text, according to various examples.

FIG. 12 illustrates a process for operating a digital assistant, according to various examples.

FIG. 13 illustrates a process for operating a digital assistant, according to various examples.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

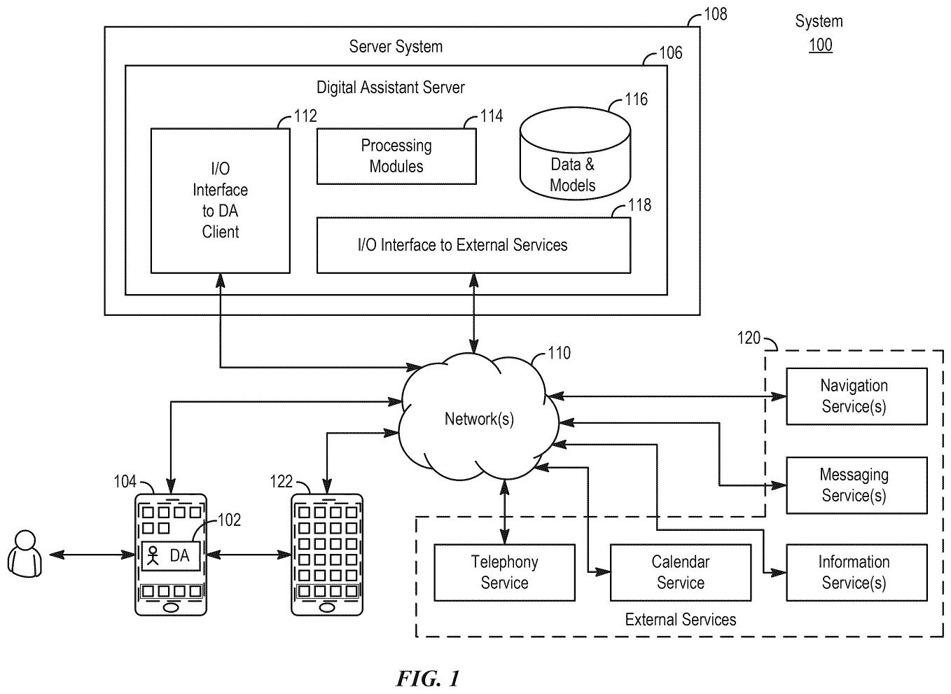

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

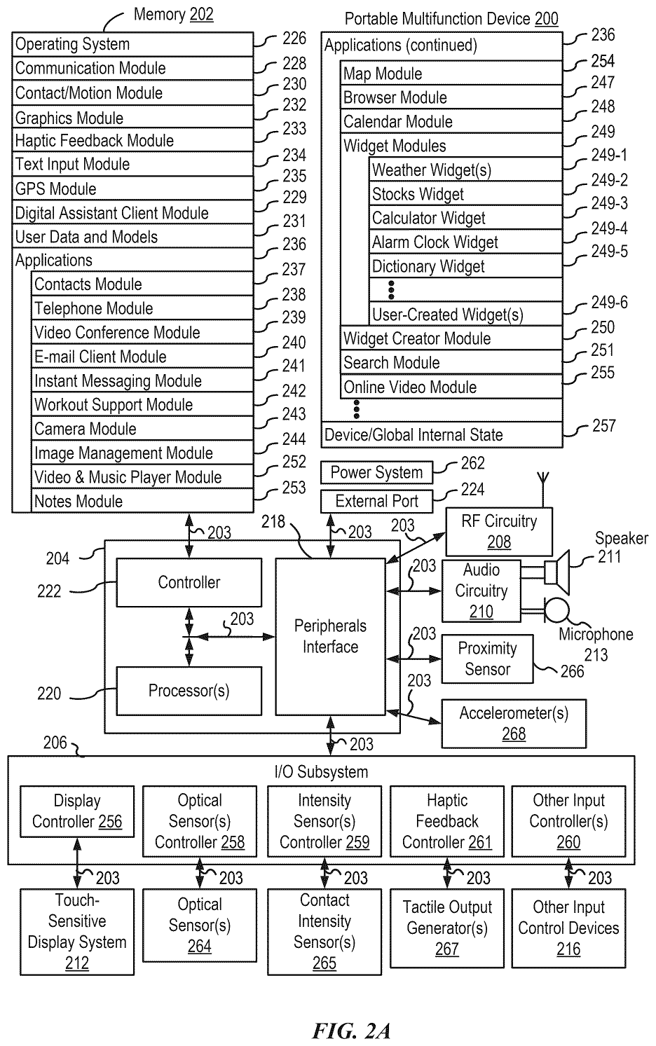

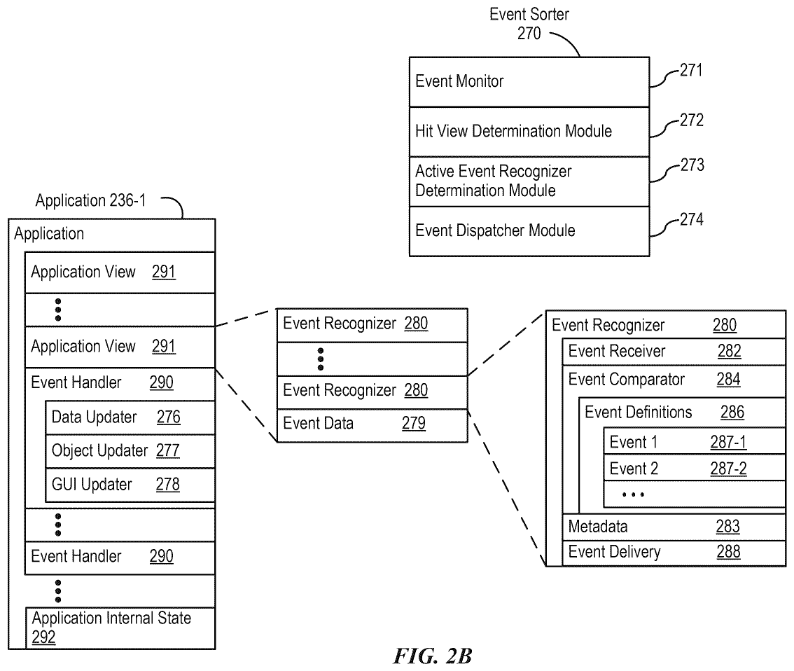

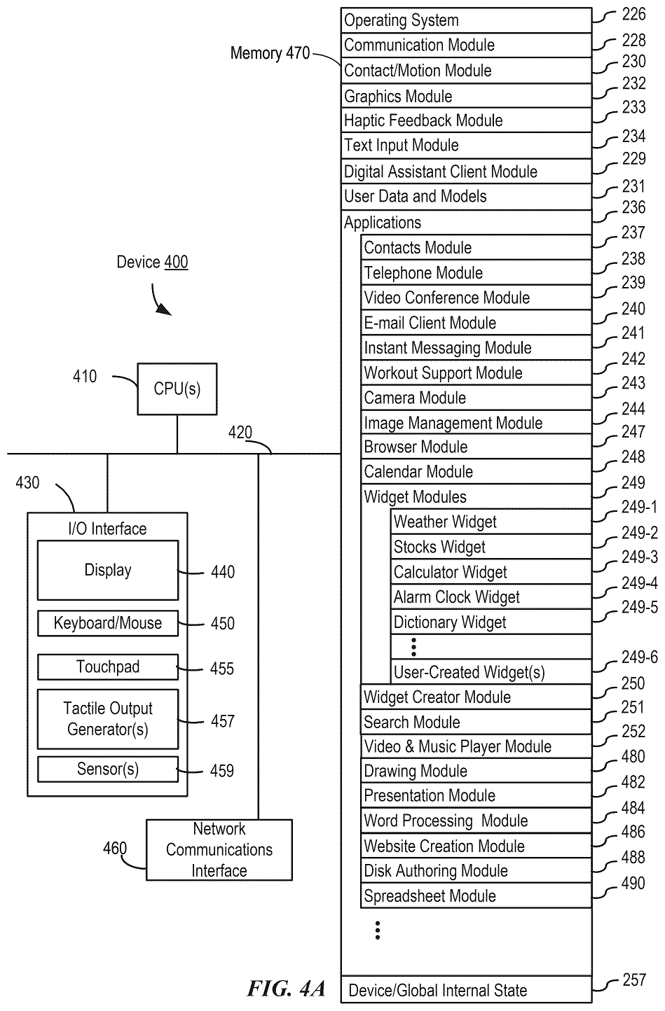

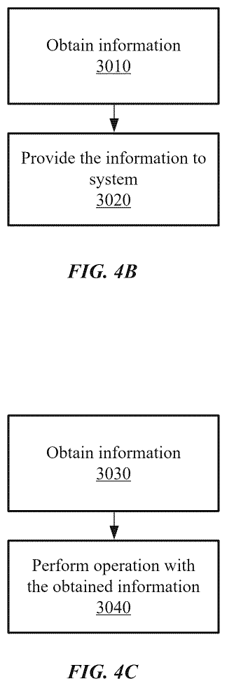

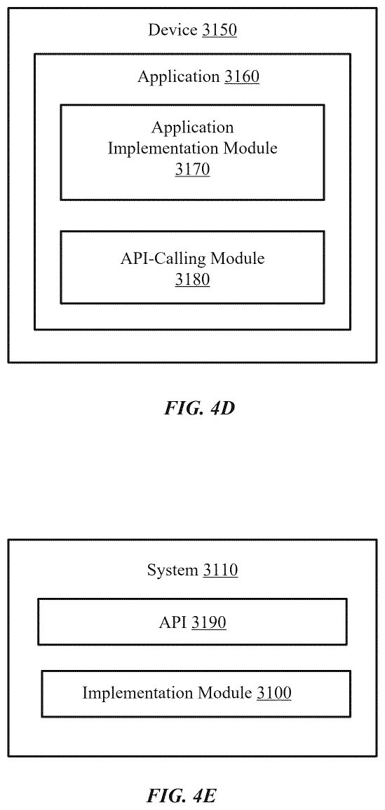

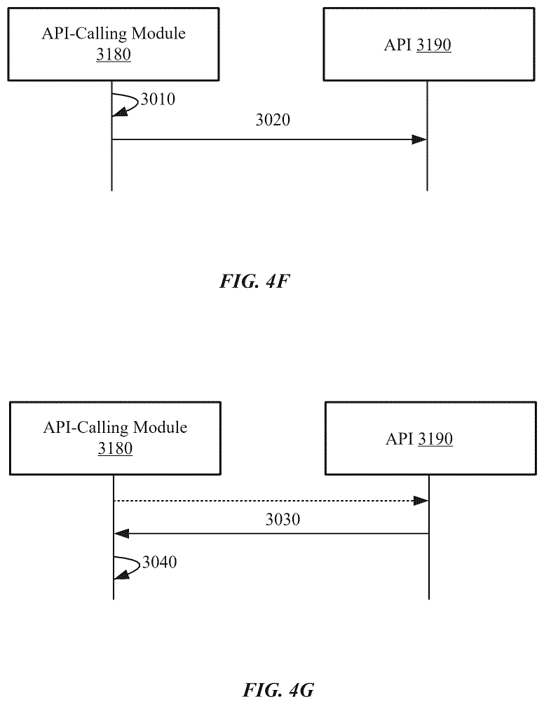

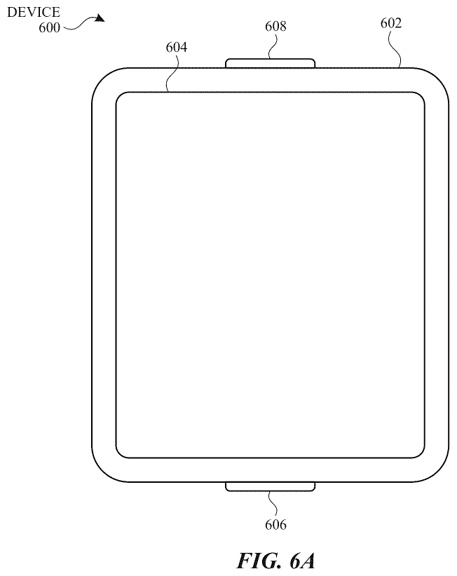

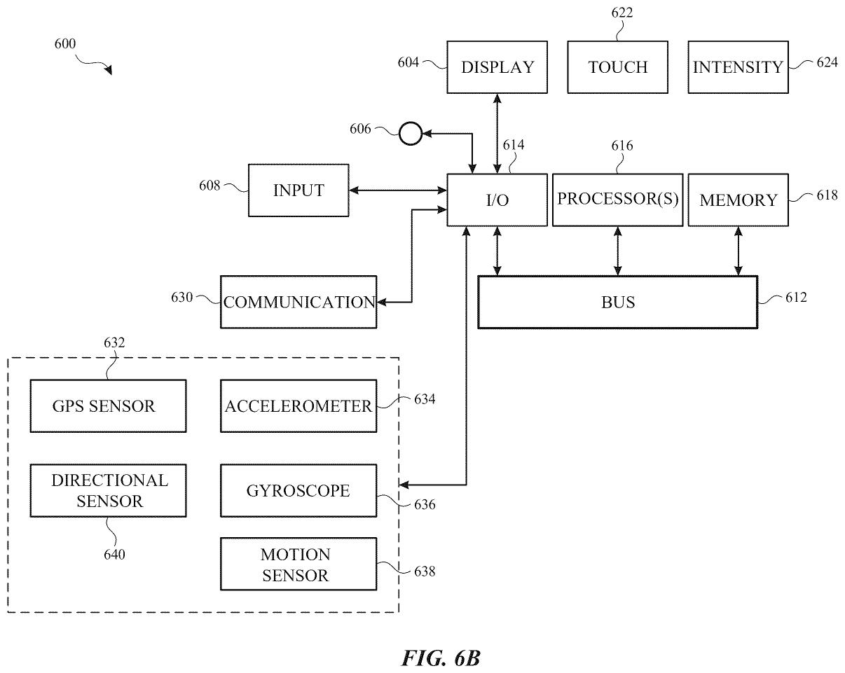

User device 104 can be any suitable electronic device. In some examples, user device 104 is a portable multifunctional device (e.g., device 200, described below with reference to FIG. 2A), a multifunctional device (e.g., device 400, described below with reference to FIG. 4A), or a personal electronic device (e.g., device 600, described below with reference to FIGS. 6A-6B). A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, California. Other examples of portable multifunction devices include, without limitation, earphones/headphones, speakers, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4A, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

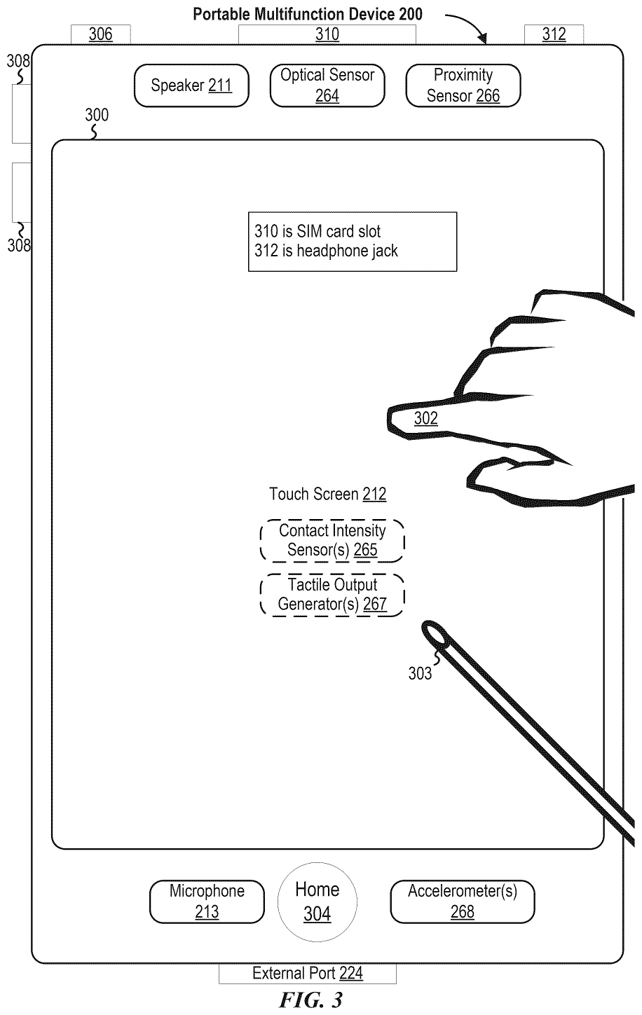

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, California.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4A) stores device/global internal state 257, as shown in FIGS. 2A and 4A. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts module 237, email client module 240, IM module 241, browser module 247, and any other application that needs text input).

GPS module 235 determines the location of the device and provides this information for use in various applications (e.g., to telephone 238 for use in location-based dialing; to camera 243 module as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

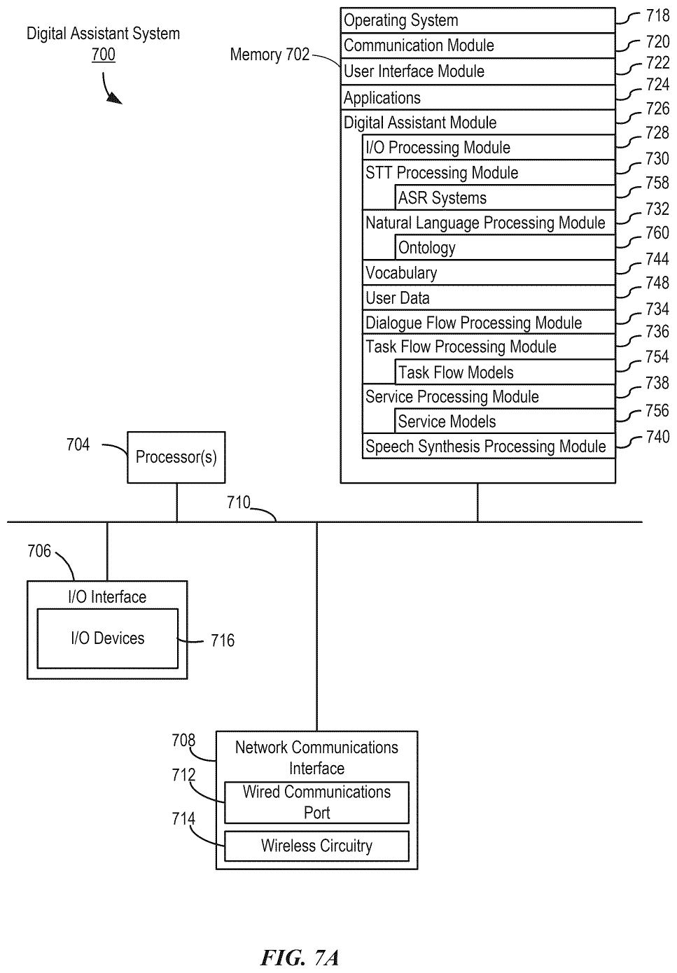

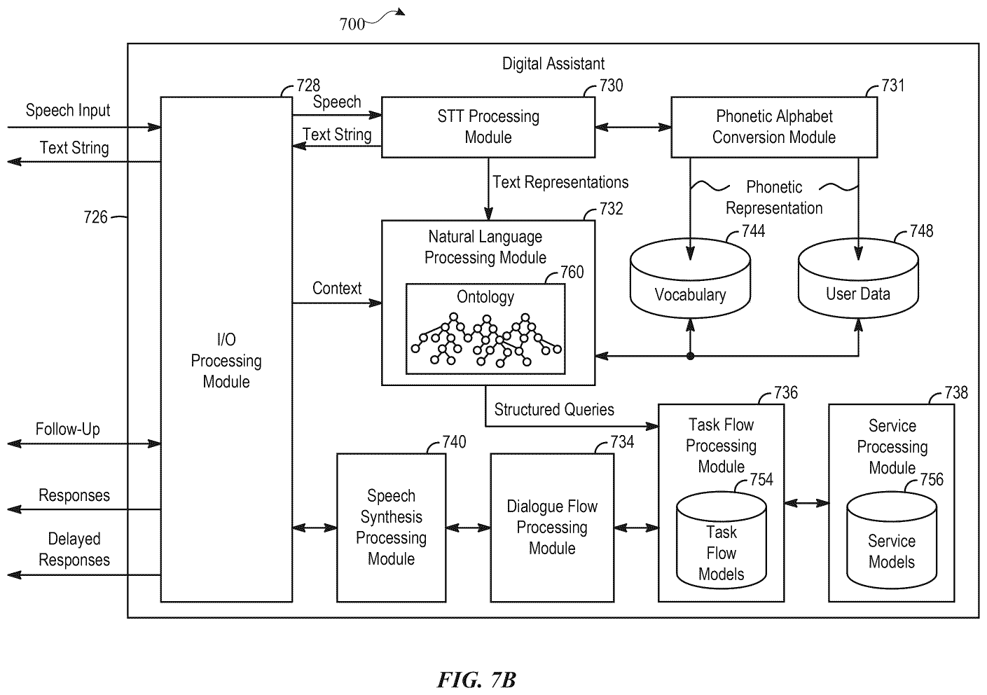

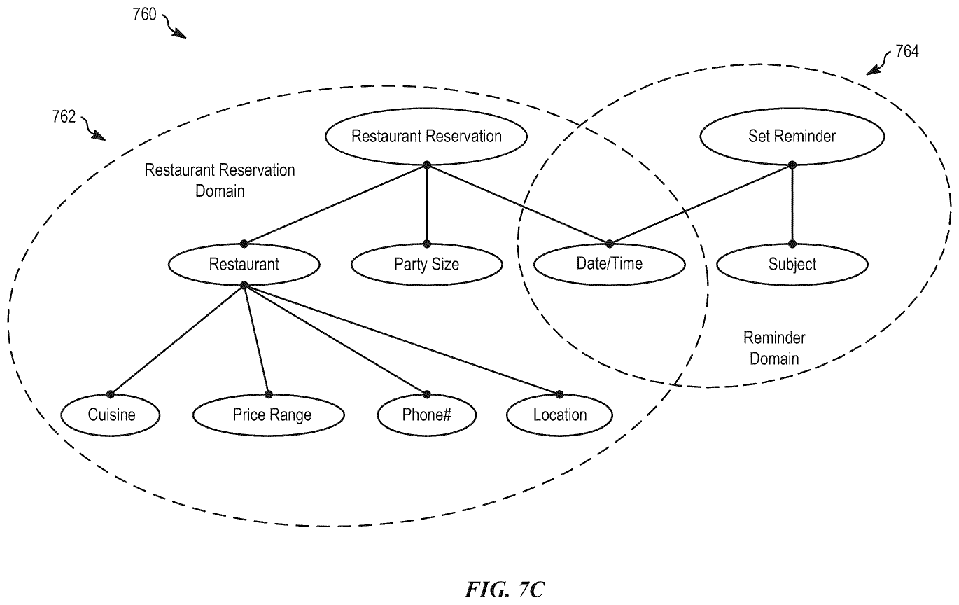

A more detailed description of a digital assistant is described below with reference to FIGS. 7A-7C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 238, video conference module 239, e-mail client module 240, or IM module 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4A) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4A is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4A is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 4B, the method of FIG. 4C, and/or one or more other processes and/or methods described herein.

It should be recognized that application 3160 (shown in FIG. 4D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 4B and FIG. 4F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 4E) is an operating system hosted on device 3150. In some embodiments, the system (e.g., 3110 shown in FIG. 4E) is an external device (e.g., a server, a peripheral device, an accessory, and/or a personal computing device) that includes an operating system.

Referring to FIG. 4C and FIG. 4G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 4B and/or the method of FIG. 4C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 4B and/or the method of FIG. 4C by calling an application programming interface (API) (e.g., API 3190) provided by system 3110. In some embodiments, application 3160 performs at least a portion of the method of FIG. 4B and/or the method of FIG. 4C without calling API 3190.

In some embodiments, one or more steps of the method of FIG. 4B and/or the method of FIG. 4C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 4D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 4D, device 3150 includes application 3160 and an operating system (e.g., system 3110 shown in FIG. 4E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 4D and 4E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 4E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

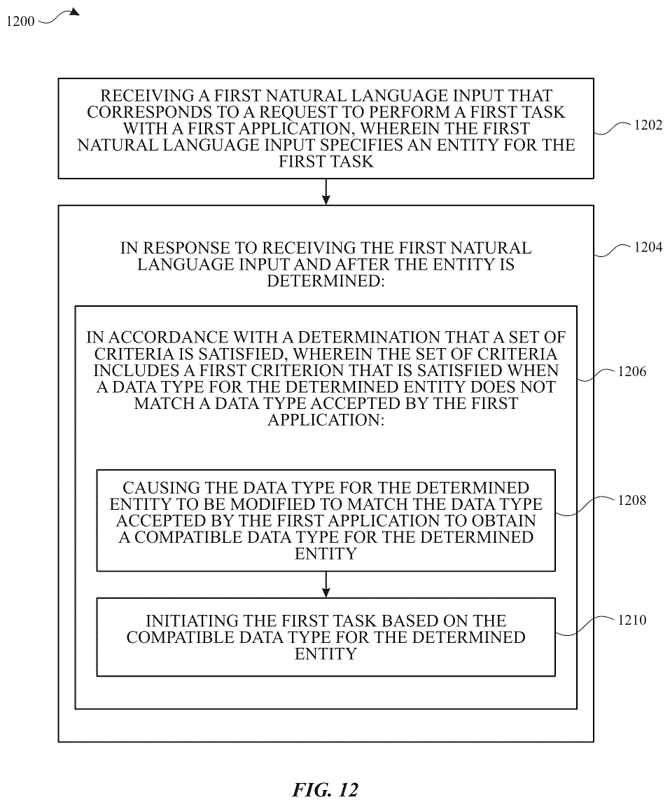

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform processes 1200 and/or 1300 (FIGS. 12 and/or 13) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that can be implemented on, for example, portable multifunction device 200.

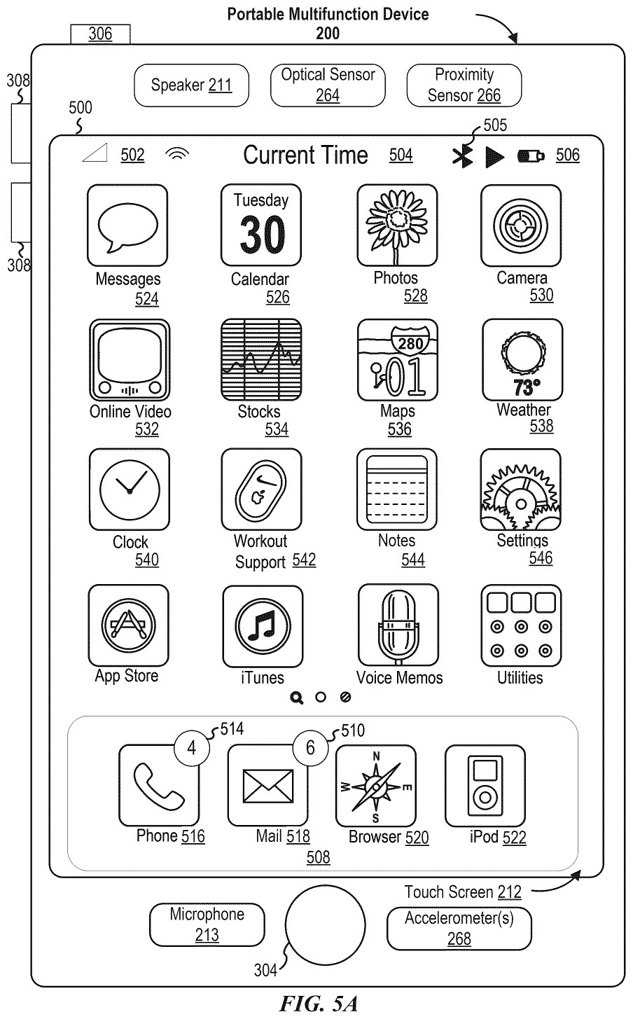

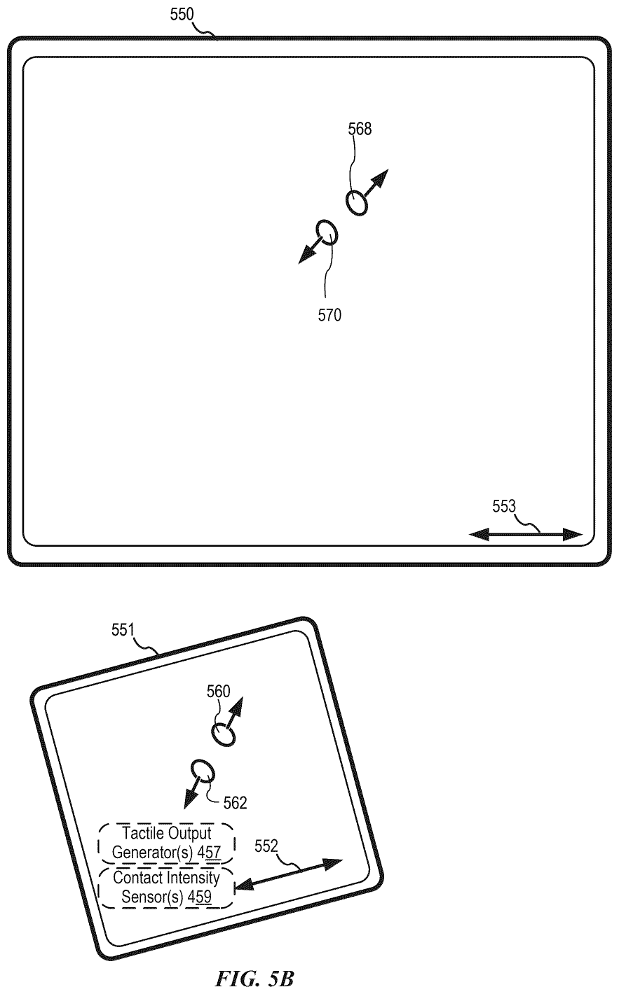

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4A) with a touch-sensitive surface 551 (e.g., a tablet or touchpad 455, FIG. 4A) that is separate from the display 550 (e.g., touch screen display 212). Device 400 also, optionally, includes one or more contact intensity sensors (e.g., one or more of sensors 459) for detecting intensity of contacts on touch-sensitive surface 551 and/or one or more tactile output generators 457 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4A). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4A. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, 600, and/or 1000 (FIGS. 2A, 4A, 6A-6B, 10A-10M, and 11A-11P). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4A or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, 600, or 1000) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, 600, or 1000 in FIGS. 2A, 4A, 6A-6B, 10A-10M, and 11A-11P. In some examples, digital assistant system 700 represents the server portion of a digital assistant implementation, and can interact with the user through a client-side portion residing on a user device (e.g., devices 104, 200, 400, 600, or 1000).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4A, 6A-6B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of /t [symbol] / and / [symbol] /. Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation / [symbol] / is ranked higher than / [symbol] /, because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation / [symbol] / is associated with the United States, whereas the candidate pronunciation / [symbol] / is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation / [symbol] / (associated with the United States) is ranked higher than the candidate pronunciation / [symbol] / (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes / [symbol] / corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes / [symbol] / corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi” } and {Time=“7 pm” }. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

FIG. 8 illustrates exemplary foundation system 800 including foundation model 810, according to various examples. In some examples, the blocks of foundation system 800 are combined, the order of the blocks is changed, and/or blocks of foundation system 800 are removed.

Foundation system 800 includes tokenization module 806, input embedding module 808, and foundation model 810 which use input data 802 and, optionally, context module 804 to train foundation model 810 to process input data 802 to determine output 812.

In some examples, the various components of digital assistant system 700 (e.g., digital assistant module 726, operating system (e.g., 226 or 718), and/or software applications (e.g., 236 and/or 724) installed on device 104, 400, 500, 600, and/or 1000) include and/or are implemented using generative artificial intelligence (AI) such as foundation model 810. In some examples, foundation model 810 include a subset of machine learning models that are trained to generate text, images, and/or other media based on sets of training data that include large amounts of a particular type of data. Foundation model 810 is then integrated into the components of digital assistant system 700 (or otherwise available to digital assistant system 700) (e.g., digital assistant module 726, operating system (e.g., 226 or 718), and/or software applications (e.g., 236 and/or 724) installed on device 104, 400, 500, 600, and/or 1000 via an API) to provide text, images, and/or other media that digital assistant system 700 uses to determine tasks, perform tasks, and/or provide the outputs of tasks.

Foundation models are generally trained using large sets unlabeled data first and then later adapted to a specific task within the architecture of digital assistant system 700. Thus, a specific task or type of output is not encoded into the foundation models, rather the trained foundation model emerges based on the self-supervised training using the unlabeled data. The trained foundation model is then adapted to a variety of tasks based on the needs of the digital assistant system 700 to efficiently perform tasks for a user.

Generative AI models, such as foundation model 810, are trained on large quantities of data with self-supervised or semi-supervised learning to be adapted to a specific downstream task. For example, foundation model 810 is trained with large sets of different images and corresponding text or metadata to determine the description of newly captured image data as output 812. These descriptions can then be used by digital assistant system 700 to determine user intent, tasks, and/or other information that can be used to perform tasks. For example, generative AI models such as Midjourney, DALL-E, and stable diffusion are trained on large sets of images and are able to convert text to a generated image.

Large language models (LLM) are a type of foundation model that provide text output after being trained on large sets of input text data. As with other foundation models, LLM's can be trained in a self-supervised manner and thus the output of different LLM's trained on the same large set of input text can be different. These LLM's can then be adapted for use with digital assistant system 700 to specific types of text. Thus, in some examples, the LLM is trained to determine a summary of text provided to the LLM as an input while in other examples, the LLM is trained to predict text based on the set of input text. Thus, the LLM can efficiently process large amounts of input text to provide the digital assistant with text that can be used to determine and/or perform tasks. For example, GPT and LLaMA are exemplary large language models that process large amounts of input text and generate text that can be used by a digital assistant, a software application, and/or an operating system.

In some examples, the LLM may be trained in a semi-supervised manner and/or provided human feedback to refine the output of the LLM. In this way, the LLM may be adapted to provide the specific output required for a particular task of digital assistant system 700, such as a summary of large amounts of text or a task for digital assistant system 700 to perform. Further, the input provided to the LLM can be adapted such that the LLM processes data as or more efficiently than digital assistant system 700 could without the use of the LLM.

Once foundation model 810 (e.g., an LLM) has been fully trained, foundation model 810 can process input data 802 as discussed below to determine output 812 which may be used to further train foundation model 810 or can be processed by digital assistant 700 to perform a task and/or provide an output to the user.

Specifically, input data 802 is received and provided to tokenization module 806 which converts input data 802 into a token and/or a series of tokens which can be processed by input embedding module 808 into a format that is understood by foundation model 810. Tokenization module 806 converts input data into a series of characters that has a specific semantic meaning to foundation model 810.

In some examples, tokenization module 806 tokenizes contextual data from context module 804 to add further information to input data 802 for processing by foundation model 810. For example, context module 804 can provide information related to input data 802 such as a location that input data 802 was received, a time that input data 802 was received, other data that was received contemporaneously with input data 802, and/or other contextual information that relates to input data 802. Tokenization module 806 can then tokenize this contextual data with input data 802 to be provided to foundation model 810.

After input data 802 has been tokenized, input data 802 is provided to input embedding module 808 to convert the tokens to a vector representation that can be processed by foundation model 810. In some examples, the vector representation includes information provided by context module 804. In some examples, the vector representation includes information determined from output 812. Accordingly, input embedding module 808 converts the various data provided as an input into a format that foundation model 810 can parse and process.

For example, when foundation model 810 is a large language model (LLM) tokenization module 806 converts input data 802 into text which is then converted into a vector representation by input embedding module 808 that can be processed by foundation model 810 to determine a response to input data 802 as output 812 or to determine a summary of input data 802 as output 812. As another example, when foundation model 810 is a model that has been trained to determine descriptions of images, input data 802 of images can be tokenized into characters and then converted into a vector representation by input embedding module 808 that is processed by foundation model 810 to determine a description of the images as output 812.

Foundation model 810 processes the received vector representation using a series of layers including, in some embodiments, attention layer 810a, normalization layer 810b, feed-forward layer 810c, and/or normalization layer 810d. In some examples, foundation model 810 includes additional layers similar to these layers to further process the vector representation. Accordingly, foundation model 810 can be customized based on the specific task that foundation model 810 has been trained to perform. Each of the layers of foundation model 810 perform a specific task to process the vector representation into output 812.

Attention layer 810a provides access to all portions of the vector representation at the same time, increasing the speed at which the vector representation can be processed and ensuring that the data is processed equally across the portions of the vector representation. Normalization layer 810b and normalization layer 810d scale the data that is being processed by foundation model 810 up or down based on the needs of the other layers of foundation model 810. This allows foundation model 810 to manipulate the data during processing as needed. Feed-forward layer 810c assigns weights to the data that is being processed and provides the data for further processing within foundation model 810. These layers work together to process the vector representation provided to foundation model 810 to determine the appropriate output 812.

For example, as discussed above, when foundation model 810 is a large language model (LLM) foundation model 810 processes input text to determine a summary and/or further follow-up text as output 812. As another example, as discussed above, when foundation model 810 is a model trained to determine descriptions of images, foundation model 810 processes input images to determine a description of the image and/or tasks that can be performed based on the content of the images as output 812.

In some examples, output 812 is further processed by digital assistant system 700 (e.g., digital assistant module 726, operating system (e.g., 226 or 718), and/or software applications (e.g., 236 and/or 724) installed on device 104, 400, 500, 600, and/or 1000) to provide an output or execute a task. For example, when output 812 is a sentence describing a task that digital assistant system 700 has performed, digital assistant system 700 can use the text to create a visual or audio output to be provided to a user. As another example, when output 812 is text that includes a function and a parameter for the function, digital assistant system 700 can perform a function call to execute the function with the provided parameter.

In some examples, digital assistant system 700 includes multiple generative AI (e.g., foundation) models that work together to process data in an efficient manner. In some examples, components of digital assistant system 700 may be replaced with generative AI (e.g., foundation) models trained to perform the same function as the component. In some examples, these generative AI models are more efficient than traditional components and/or provide more flexible processing and/or outputs for digital assistant system 700 to utilize.

### 4. Digital Assistant Responses in Application User Interfaces

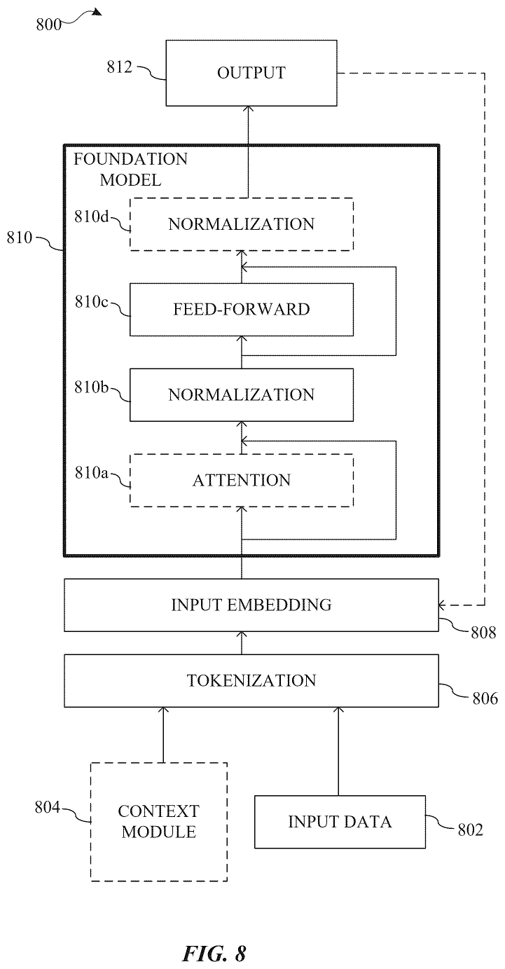

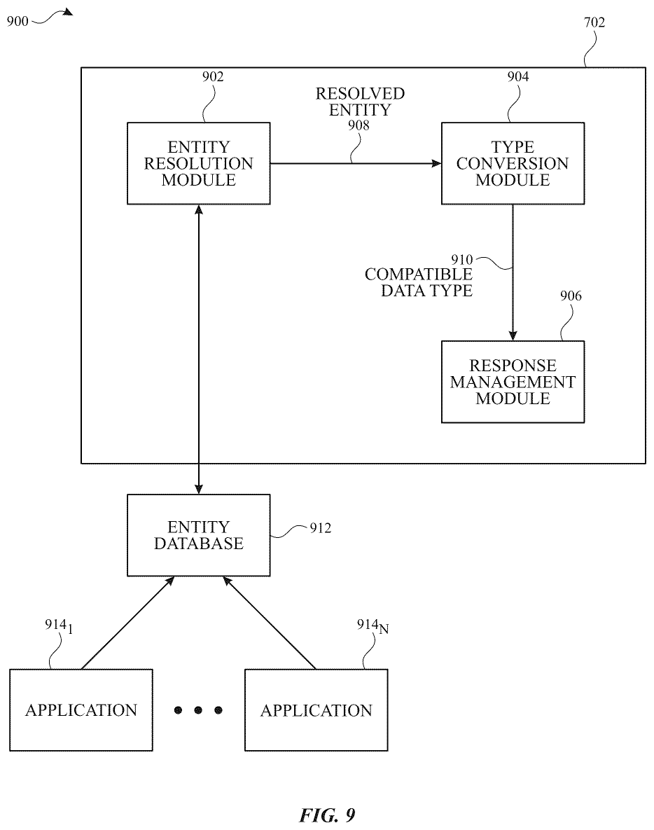

FIG. 9 illustrates a block diagram of system 900 for integrating digital assistant functionality with the functionalities of other software applications, according to various examples. In some examples, system 900 is implemented on a standalone computer system (e.g., device 104, 122, 200, 400, 600, or 1000). In some examples, system 900 is distributed across multiple computers. For example, some of the components and functions of system 900 are divided into a server portion and a client portion, where the client portion resides on one or more user devices (e.g., devices 104, 122, 200, 400, 600, or 1000) and communicates with the server portion (e.g., server system 108) through one or more networks, e.g., as shown in FIG. 1. In some examples, at least some of the components and functions of system 900 are implemented within digital assistant system 700, as described above with respect to FIGS. 7A-7C and 8. For example, as shown, entity resolution module 902, type conversion module 904, and response management module 906 are each implemented as a respective set of computer-executable instructions stored in memory 702. In some examples, entity database 912 and applications 914₁-914_{N} are also each implemented as a respective set of computer-executable instructions stored in memory 702 of digital assistant system 700. In some examples, entity database 912 and applications 914₁-914_{N} are each implemented as a respective set of computer-executable instructions stored in another memory (e.g., memory(ies) 202, 470, and/or 618).

System 900 includes entity resolution module 902. Entity resolution module 902 is configured to resolve (e.g., determine, disambiguate, and/or determine a particular value for) an entity that a natural language input refers to. Entity resolution module 902 is further configured to provide resolved entity 908 to type conversion module 904 (discussed below) for further processing. An entity can take many different forms and a digital assistant can perform various tasks based on different entities. Example entities include a person, a person's contact information (e.g., phone number, email address, physical address, social media identifier, and the like), a media item (e.g., song, video, photo, and/or audiobook), a location, a restaurant reservation, a file, a note, a calendar invite, a smart home device, a flight booking, health information, biometric information, a message, financial information, a sports team, a sports game, and the like.

In some examples, entity resolution module 902 resolves the entity by searching entity database 912 for the entity. Entity database 912 includes (e.g., stores and/or references) various entities associated with a user device, e.g., device 1000. In some examples, entity database 912 further includes metadata associated with a respective entity, e.g., a time associated with the entity, a location associated with the entity, a description of the entity, information about user interactions with the entity (e.g., user views of the entity, user selections of the entity, and/or user actions performed based on the entity), information about the times of such user interactions, information about the frequency of such user interactions, and the like. In some examples, entity resolution module 902 resolves the entity based on the metadata. For example, if a natural language input requests photos from a specific location, entity resolution module 902 determines the photos based on metadata indicating the specific location of the photos, and optionally, based on metadata indicating that the photos were recently taken. As another example, if a natural language input requests a person's contact information but is ambiguous regarding the specific person (e.g., specifies the person's first name but not the last name), entity resolution module 902 disambiguates the specific person based on metadata indicating that the user most frequently interacts with the specific person.

Applications 914₁-914_{N} include various software applications, e.g., installed on device 104, 122, 200, 400, 600, and/or 1000. Example software applications include a music application, a flight booking application, a text editing application, a camera application, a photos application, a restaurant booking application, a ride booking application, a drawing application, a home security application, a navigation application, a health application, a financial application, and the like. In some examples, at least one of applications 914₁-914_{N} is an application that is pre-installed on a user device (e.g., device 1000) at purchase (e.g., a first-party application). In some examples, at least one of applications 914₁-914_{N} is an application that is provided to the user device via an operating system update file (e.g., a first-party application or a second-party application). In some examples, at least one of applications 914₁-914_{N} is an application that is provided via an application store. In some examples, the application store is an application store that is pre-installed on the user device at purchase (e.g., a first-party application store). In some examples, the application store is a third-party application store (e.g., an application store that is provided by another application store, downloaded via a network, and/or read from a storage device). In some examples, at least one of applications 914₁-914_{N} is a third-party application (e.g., an application that is provided by an application store, downloaded via a network, and/or read from a storage device).

In some examples, one or more of applications 914₁-914_{N} provide information about their respective entities to entity database 912. In some examples, the application provides metadata about its respective entities to entity database 912. In some examples, the application provides information about one or more data types (e.g., file types) the respective entities can be expressed as (e.g., exported as, transformed into, and/or converted into). For example, a restaurant reservation application provides, to entity database 912, a restaurant reservation entity (e.g., representing a restaurant reservation of a user) and information indicating that the restaurant reservation entity can be expressed as a location. As another example, a photos application provides, to entity database 912, photos associated with the application and information indicating the file types (e.g., jpg, .jpeg, and/or .png) the photos can be expressed as. As yet another example, a messaging application provides, to entity database 912, contact information associated with the application (e.g., contact information for the user's friends) and information indicating that the contact information can be expressed in .vcf format as vCards.

In some examples, the application provides the aforementioned information upon installation on a user device. In some examples, the application provides and/or updates the aforementioned information periodically, e.g., every hour, every day, or every week. In some examples, entity resolution module 902 generates and sends a query to the application for such information and the application provides the aforementioned information in response to the query.

System 900 includes type conversion module 904. Type conversion module 904 is configured to determine whether to convert a data type for resolved entity 908 into compatible data type 910. Compatible data type 910 is accepted by an application that is to perform a user requested task based on resolved entity 908. Conversion of the data type may be desirable because the application that is to perform the task may not be configured to accept (e.g., process or otherwise act upon) certain data types. For example, a messaging application may only accept images in a specific format (e.g., .png and .jpeg), a navigation application may only accept location information in a specific format (e.g., as GPS coordinates or as text), and a note taking application may only accept contact information in a specific format (e.g., as a vCard). In some examples, each application defines the data type(s) that are accepted. Accordingly, when the data type for resolved entity 908 does not match the data type accepted by the application, for the digital assistant to perform the user requested task, type conversion module 904 converts the data type into compatible data type 910.

In some examples, type conversion module 904 determines compatible data type 910 based on the natural language input and information that indicates the data type(s) resolved entity 908 can be expressed as. In this manner, type conversion module 904 converts the data type for resolved entity 908 into a different data type that resolved entity 908 can be expressed as. As a particular example, for the user request “navigate to my restaurant reservation tonight,” entity resolution module 902 determines resolved entity 908 to be the requested restaurant reservation. However, a restaurant reservation application provides the restaurant reservation in a data type that the navigation application is not configured to accept. Type conversion module 904 determines, based on the natural language input and the data type(s) accepted by the navigation application, that a location data type is instead appropriate for the navigation application. Then, based on information indicating that the restaurant reservation can be expressed as a GPS location, type conversion module 904 converts the restaurant reservation data type into a GPS location data type to obtain compatible data type 910.

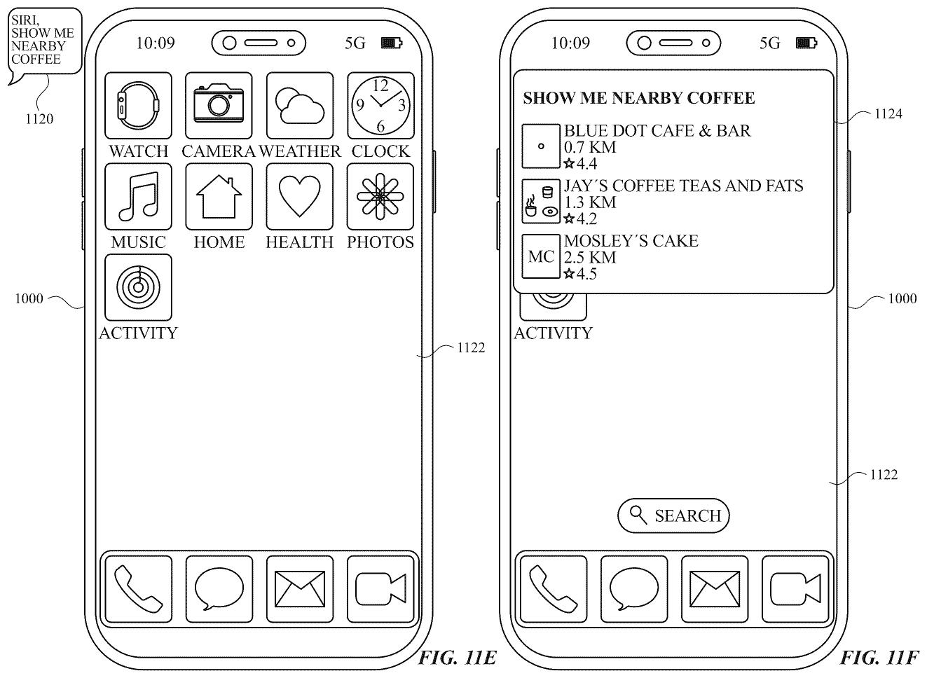

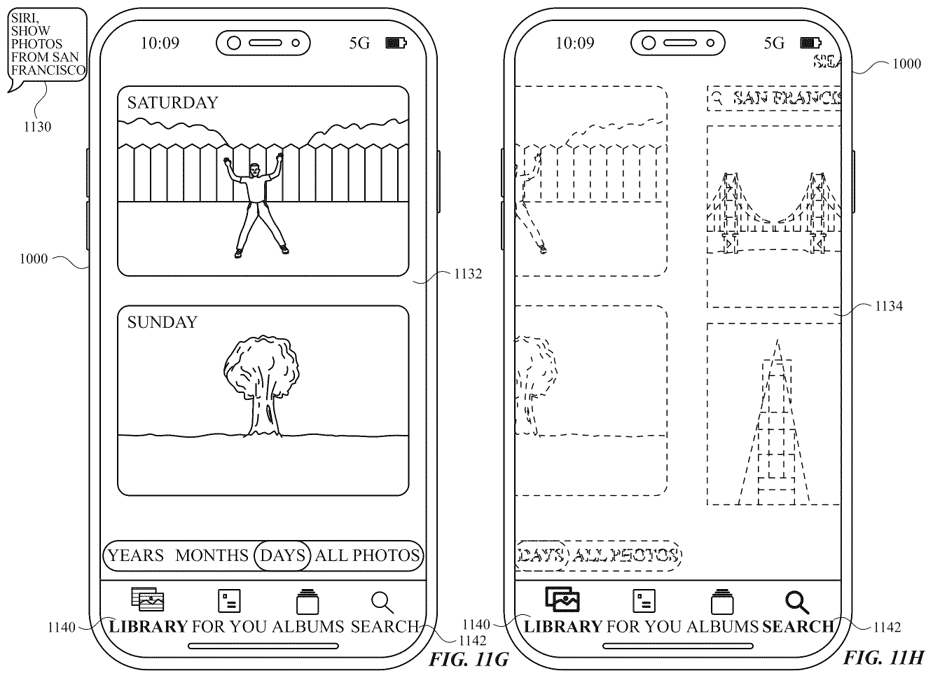

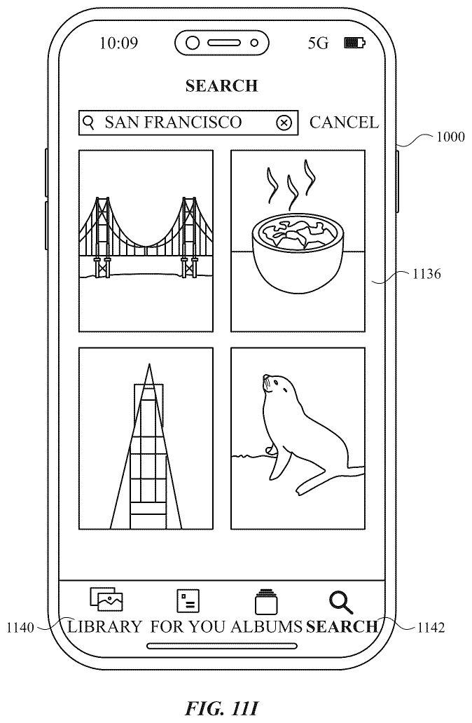

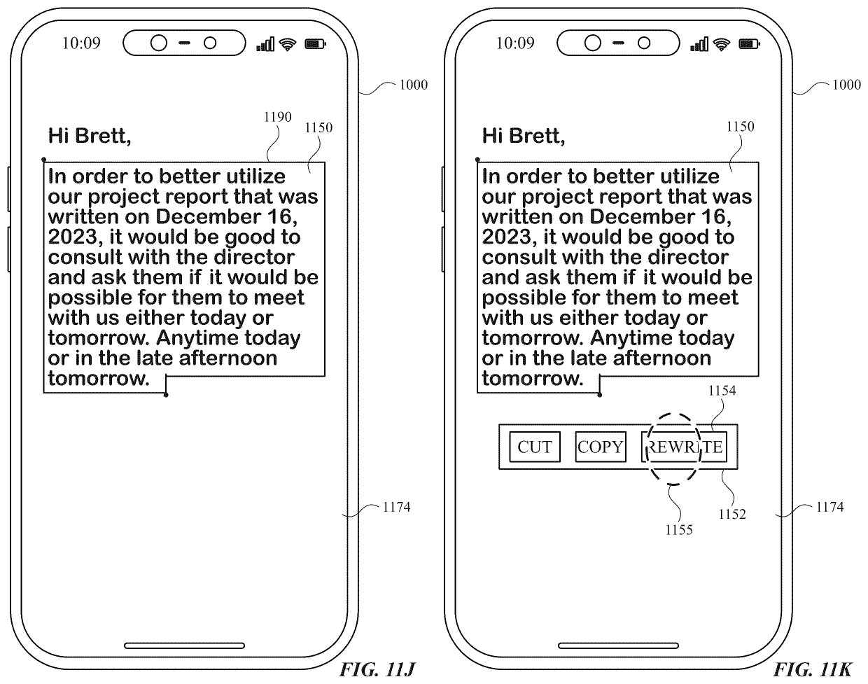

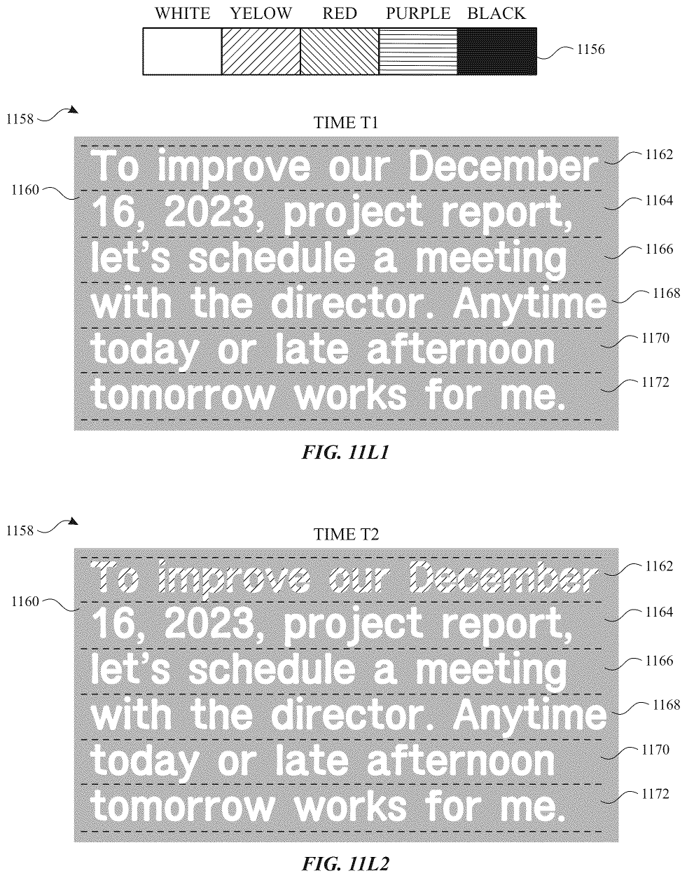

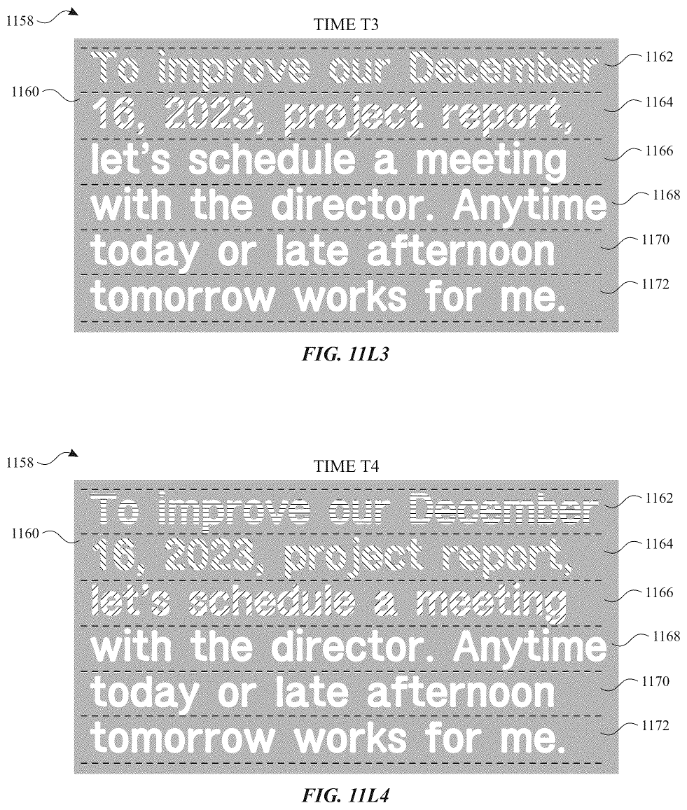

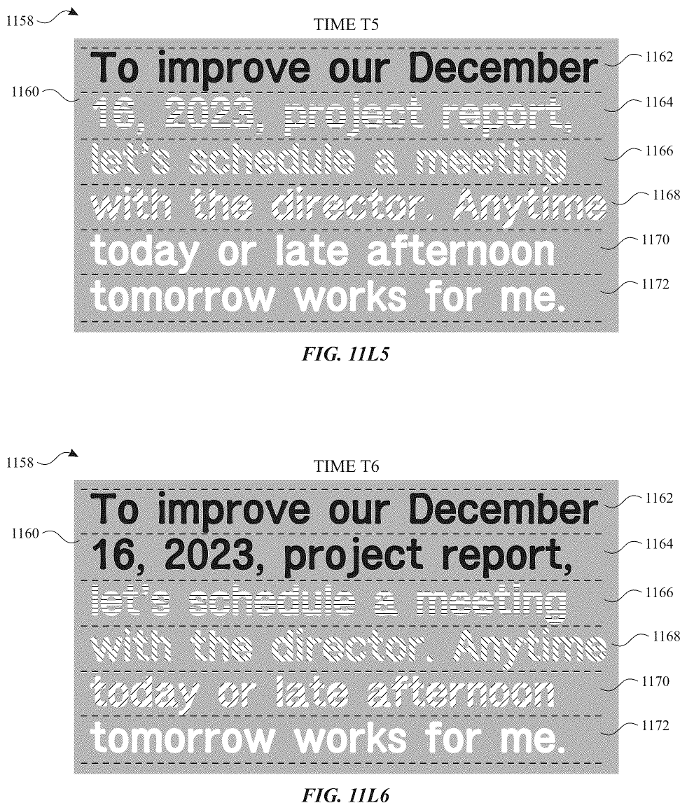

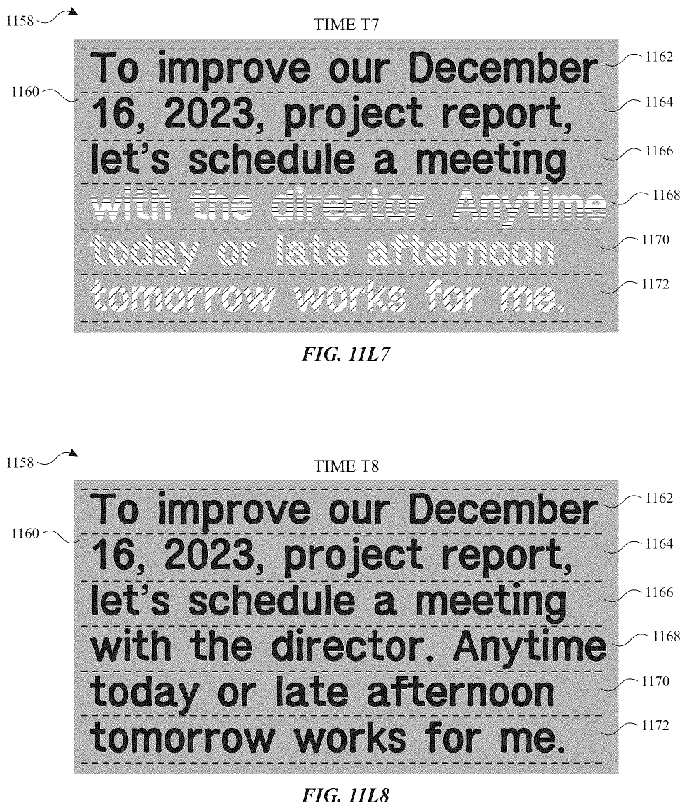

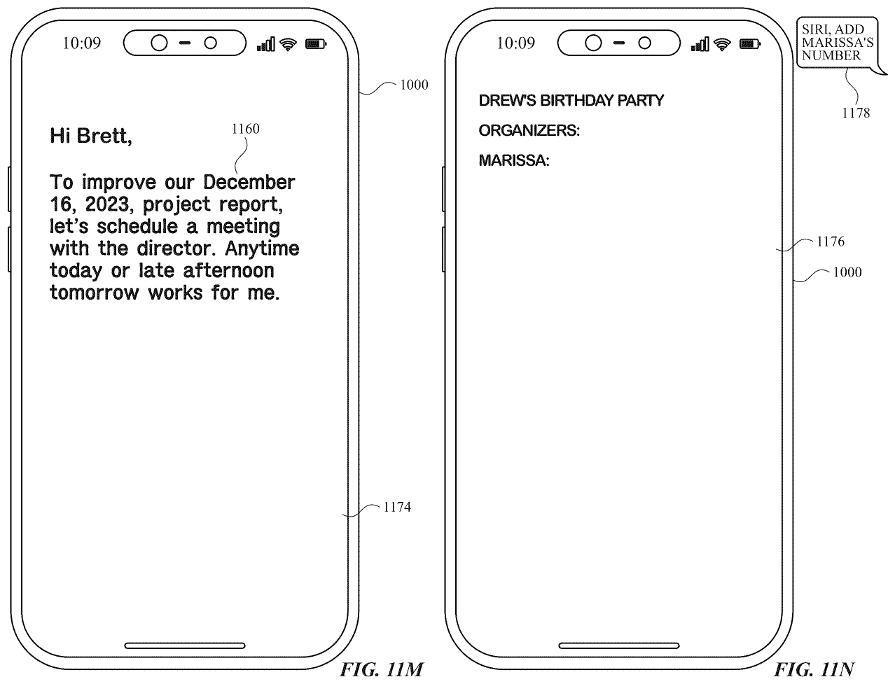

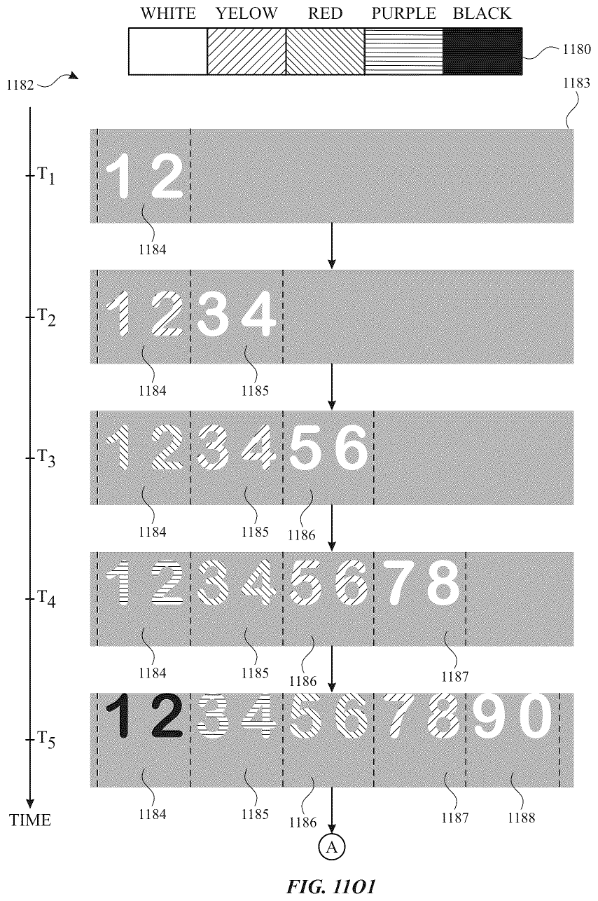

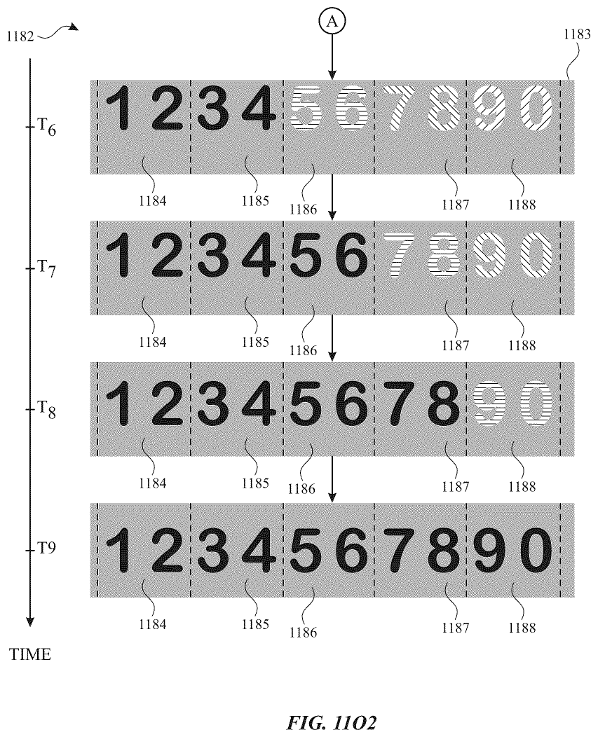

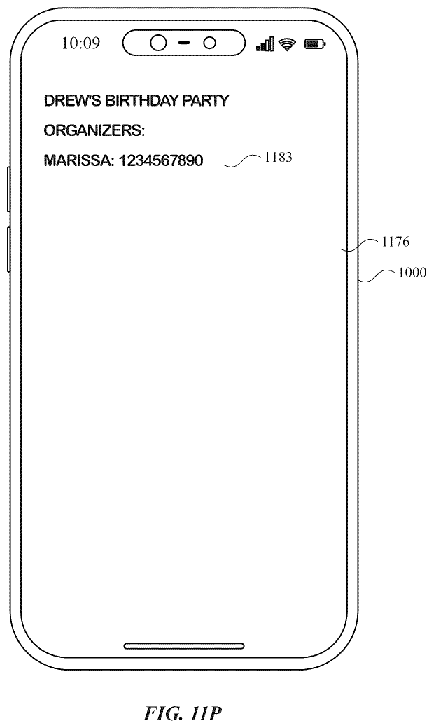

System 900 includes response management module 906. Response management module 906 is configured to accept compatible data type 910 and to cause the digital assistant to perform the requested task based on compatible data type 910. In some examples, response management module 906 operates in conjunction with task flow processing module 736 to perform the task, e.g., by providing compatible data type 910 as a parameter of a task flow implemented within task flow models 754. Response management module 906 is further configured to coordinate the user-facing experience of a digital assistant, as discussed below with respect to FIGS. 11A-11P.

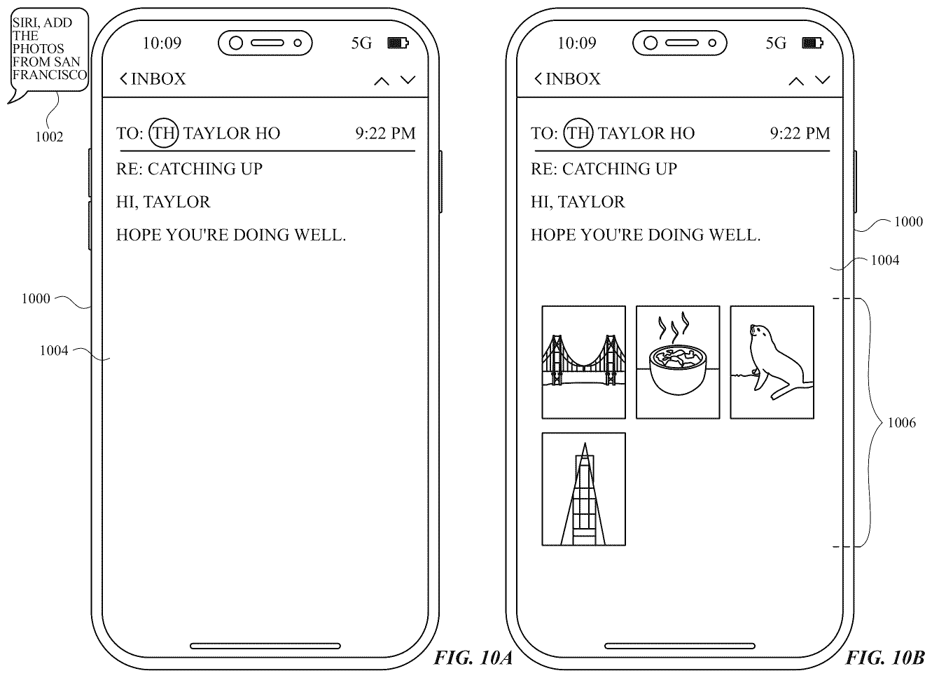

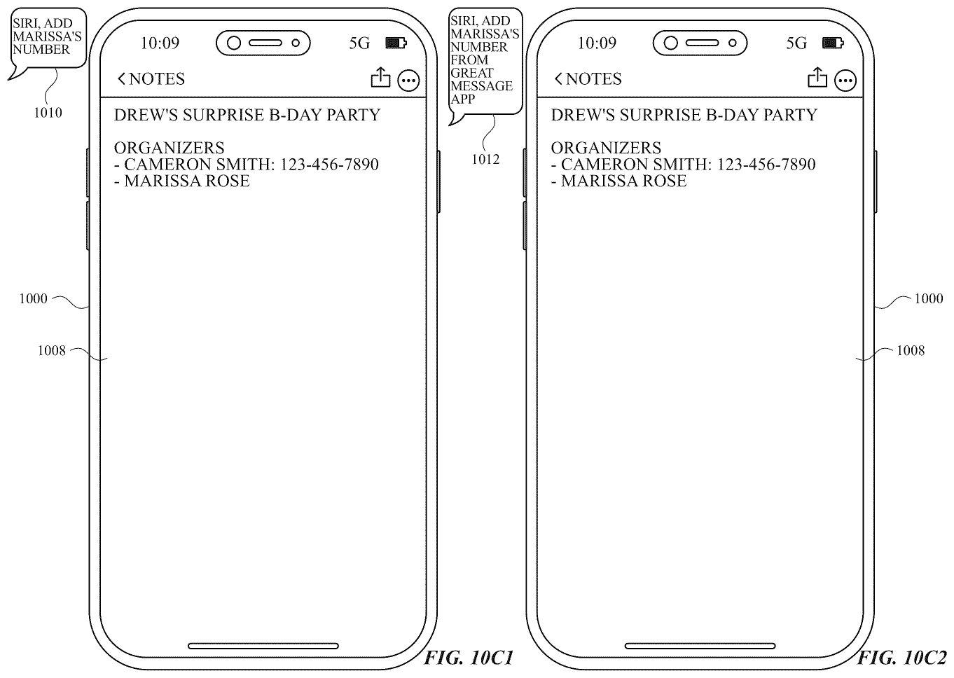

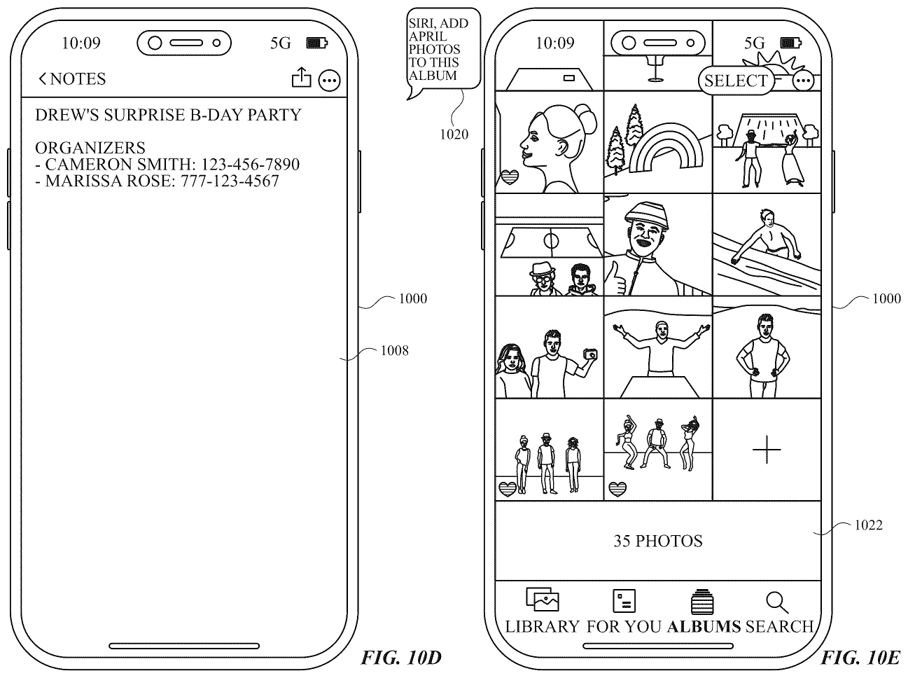

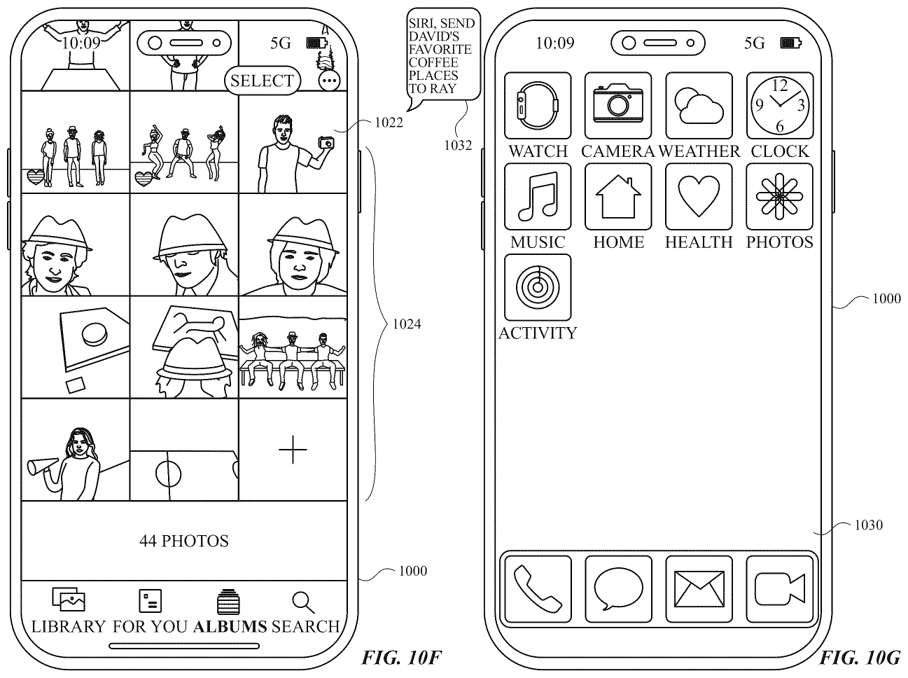

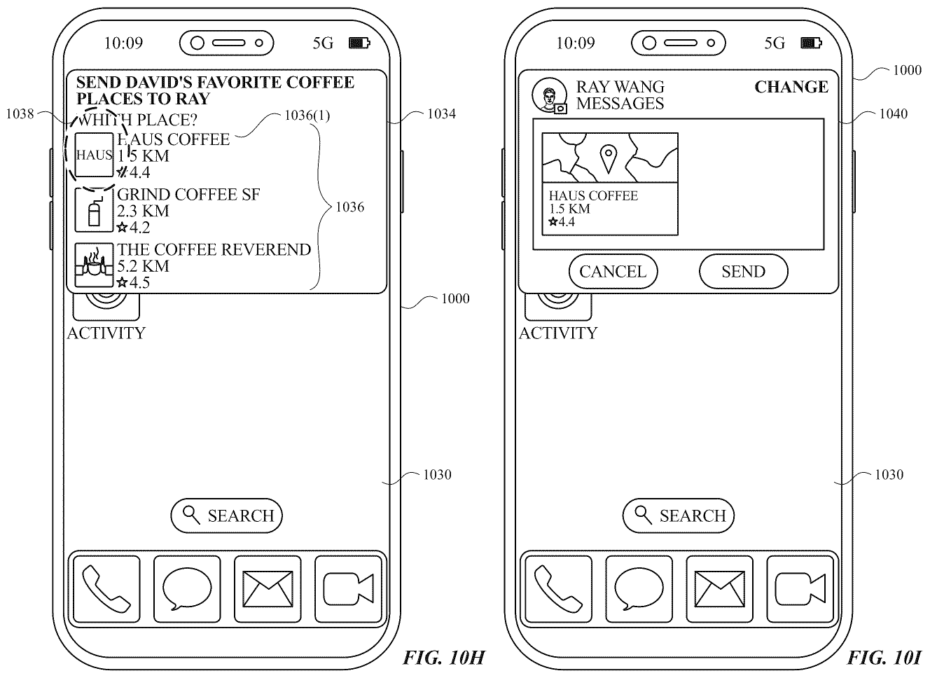

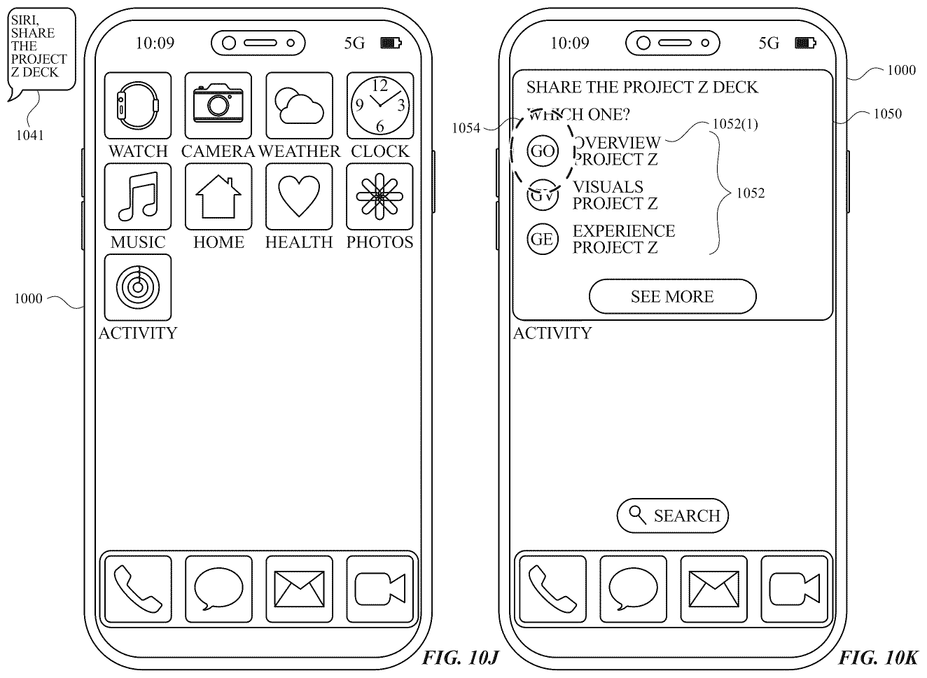

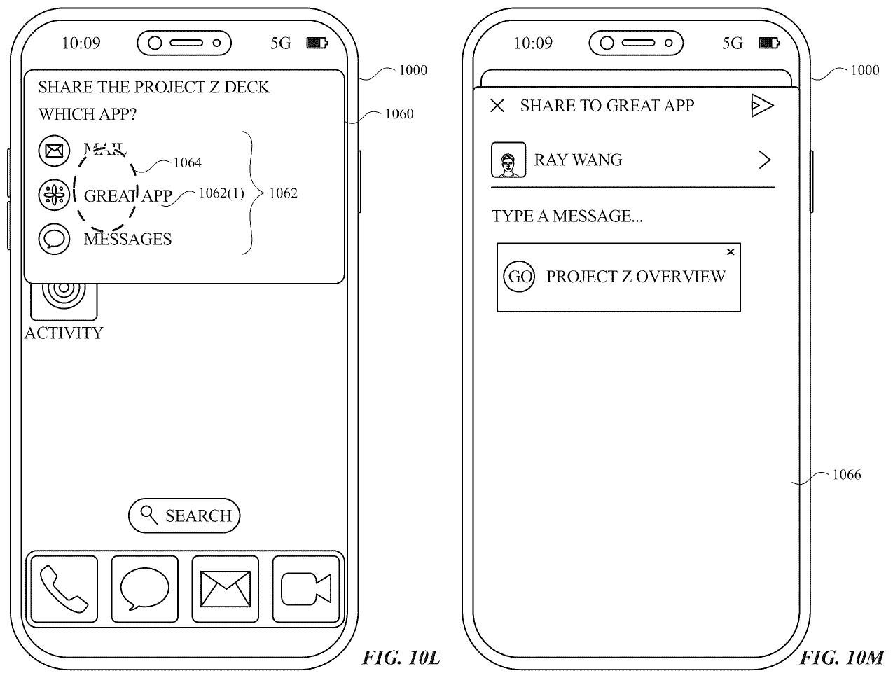

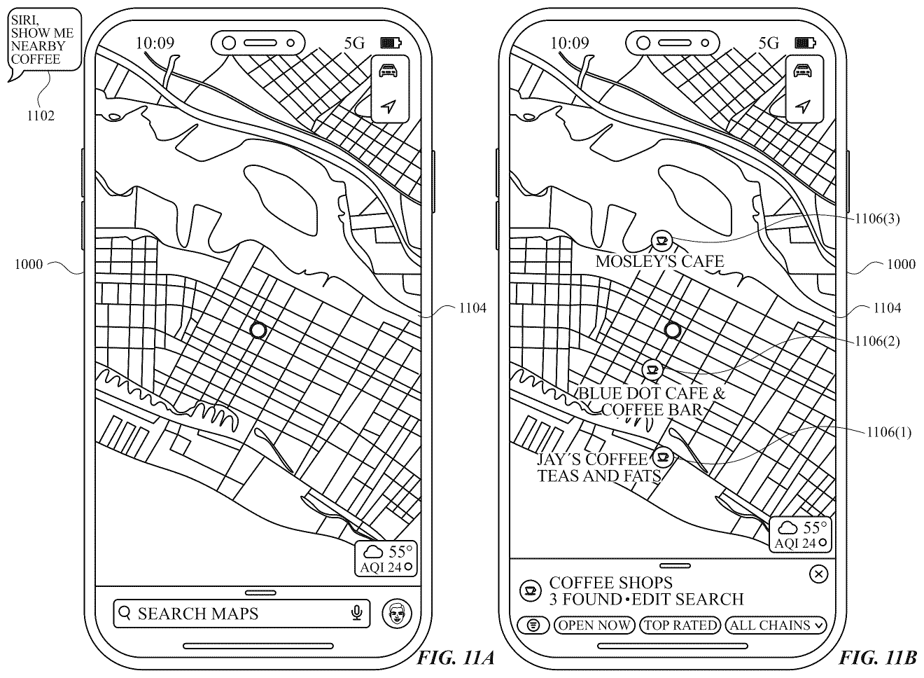

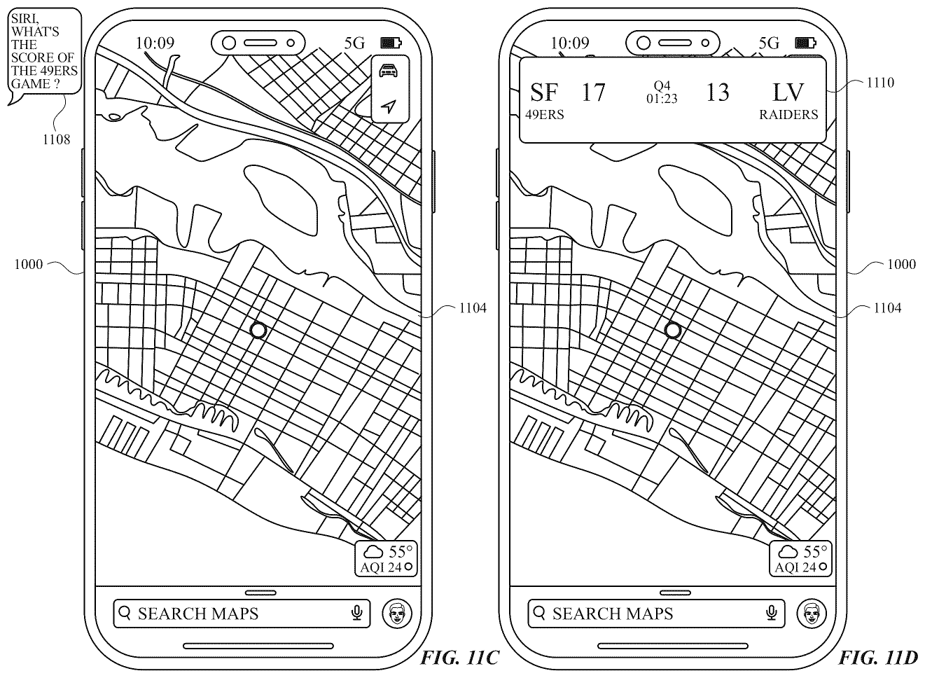

The components and functions of system 900 are now described in greater detail with respect to FIGS. 10A-10M and FIGS. 11A-11P.

FIGS. 10A-10M illustrate various user interactions with a digital assistant that operates on device 1000, according to various examples. Device 1000 is implemented as device 104, 122, 200, 400, or 600. Device 1000 at least partially implements DA system 700 and at least partially implements system 900. While the examples of FIGS. 10A-10M and 11A-11P show that device 1000 is implemented as a smartphone device, device 1000 can be implemented as another type of device, such as a head mounted device (e.g., a headset, smart glasses, or goggles), a smart watch, a tablet device, a laptop computer, a desktop computer, a smart speaker, or a smart home device.

In FIG. 10A, while displaying messaging application user interface 1004, device 1000 receives speech input 1002 “Siri, add the photos from San Francisco.” In the present example, speech input 1002 includes a trigger expression (e.g., “Siri”) to indicate that speech input 1002 is intended for the digital assistant. In other examples, a user can issue requests to the digital assistant without providing a trigger expression.

Speech input 1002 requests to perform a task with the messaging application, specifically the task of attaching the entity of “photos from San Francisco” to a current message. In response to speech input 1002, entity resolution module 902 resolves “photos from San Franscisco” by searching entity database 912 for photos 1006 (FIG. 10B) taken in San Francisco, California. When initially obtained, photos 1006 each have a data type that the messaging application is not configured to accept (e.g., because a photos application provides photos 1006 in an incompatible data type). Type conversion module 904 determines that the messaging application is instead configured to accept photos in .png format and further determines (e.g., based on information from entity database 912) that photos 1006 can each be expressed in .png format. Type conversion module 904 then converts each of photos 1006 from the incompatible format to the compatible .png format. Once converted, type conversion module 904 provides photos 1006 to response management module 906 to complete the task. For example, in FIG. 10B, device 1000 completes the task by attaching photos 1006 to the current message.

In FIG. 10C1, while displaying note taking application user interface 1008, device 1000 receives speech input 1010 “Siri, add Marissa's number.” Speech input 1010 requests to perform a task with the note taking application, specifically the task of adding Marissa's phone number to the current note. In response to speech input 1008, entity resolution module 902 attempts to resolve (e.g., disambiguate) Marissa by searching entity database 912 for a contact named Marissa. However, entity resolution module 902 cannot find a match for a contact named Marissa in entity database 912. This may be because entity database 912 does not include a contact named Marissa, e.g., because none of applications 914₁-914_{N} have provided contact information for Marissa. Because entity resolution module 902 cannot find a match for a contact named Marissa in entity database 912, entity resolution module 902 initiates a query to at least one of applications 914₁-914_{N} for contacts named Marissa. In some examples, entity resolution module 902 selects the application(s) to query based on the entity type and the application type, e.g., based on which applications are likely to include contact information. In response to receiving the query(ies), at least one of applications 914₁-914_{N} provide, to entity resolution module 902 and/or to entity database 912, information for respective contacts named Marissa and information about the data type(s) (e.g., vCards) the contact information can be expressed as.

Based on the information received in response to the query, entity resolution module 902 determines Marissa to be the contact Marissa Rose. However, when entity resolution module 902 initially obtains the contact information for Marissa Rose, the contact information has a data type that the note taking application is not configured to accept (e.g., because the application provides the contact information in an incompatible data type). Type conversion module 904 determines that the note taking application is instead configured to accept information in text format and further determines that the contact information can be expressed in vCard format (e.g., a format from which the digital assistant can extract text). Type conversion module 904 then converts the contact information into vCard format and extracts the text corresponding to Marissa Rose's phone number from the vCard. Type conversion module 904 then provides the text for Marissa Rose's phone number to response management module 906 to complete the task. For example, in FIG. 10D, device 1000 completes the task by adding Marissa Rose's phone number to the current note.

FIGS. 10C2 and 10D illustrate another example of querying an application for an entity and the data type(s) that the entity can be expressed as. In FIG. 10C2, while displaying note taking application user interface 1008, device 1000 receives speech input 1012 “Siri, add Marissa's number from Great Message App.” Like speech input 1010, speech input 1012 requests to perform the task of adding Marissa's phone number to the current note. However, unlike speech input 1010, speech input 1012 specifies an application (e.g., Great Message App) for the entity of Marissa. Because speech input 1012 specifies the application, in response to speech input 1012, entity resolution module 902 initiates a query to the specified Great Message App for contacts named Marissa. In response to receiving the query, the Great Message App provides, to entity resolution module 902 and/or to entity database 912, information for contacts named Marissa and information about the data type(s) (e.g., vCards) the contact information can be expressed as. Based on the information received in response to the query, entity resolution module 902 determines Marissa to mean the contact Marissa Rose. System 900 then completes the requested task of adding Marissa's phone number from Great Message App to the current note in a manner analogous to that discussed above with respect to FIGS. 10C1 and 10D.

In FIG. 10E, while displaying photos application user interface 1022, device 1000 receives speech input 1020 “Siri, add April photos to this album.” Speech input 1020 requests to perform a task with the photos application, specifically the task of adding the entity of April photos to the current photo album. In response to speech input 1020, entity resolution module 902 resolves April photos by searching entity database 912 for relevant photos 1024 (FIG. 10F) taken in April of the current year. When initially obtained, photos 1024 each have a data type that the photos application is configured to accept (e.g., because the same photos application as the one with user interface 1022 provides photos 1024). Accordingly, type conversion module forgoes converting the data type of photos 1024 and provides unconverted photos 1024 to response management module 906 to complete the task. For example, in FIG. 10F, device 1000 completes the task by adding photos 1024 to the current photo album.

In FIG. 10G, while displaying home screen user interface 1030, device 1000 receives speech input 1032 “Siri, send David's favorite coffee places to Ray.” Speech input 1032 specifies the entity of David's favorite coffee places and requests to perform a task with a messaging application. In response to speech input 1032, entity resolution module 902 attempts to resolve the entity of David's favorite coffee places. However, entity resolution module 902 cannot confidently identify a set of David's favorite coffee places. Thus, in FIG. 10H, entity resolution module 902 causes device 1000 to display candidates 1036 for David's favorite coffee places in graphical response 1034. In FIG. 10H, device 1000 further prompts the user to select which of David's favorite coffee places they would like to send.

In FIG. 10H, device 1000 receives touch input 1038 that selects candidate 1036(1) for David's favorite coffee places. In response to touch input 1038, type conversion module 904 determines that candidate 1036(1) has a data type that the messaging application does not accept (e.g., because another application provided candidate 1036(1) in an incompatible data type). Accordingly, type conversion module 904 converts candidate 1036(1) into a data type compatible with the messaging application, e.g., based on information, from the application that provided candidate 1036(1), that candidate 1036(1) can be expressed as a data type compatible with the messaging application. After conversion, type conversion module 904 provides candidate 1036(1) to response management module 906 to complete the task. For example, in FIG. 10I, in response to receiving touch input 1038, device 1000 displays graphical response 1040 showing that a message to Ray includes the user-selected David's favorite coffee place.

Notably, in FIGS. 10H-10I, type conversion module 904 does not convert the data type of all candidates 1036 to respective data types accepted by the messaging application. Rather, in response to a user selection of candidate 1036(1), type conversion module 904 converts the data type of selected candidate 1036(1) into an accepted data type. In this manner, type conversion module 904 conserves processing resources by not converting the data types of undesired candidates.

In FIG. 10J, device 1000 receives speech input 1041 “Siri, share the Project Z deck.” Speech input 1041 requests to perform the task of sharing the entity of the Project Z deck. In response to speech input 1041, entity resolution module 902 attempts to resolve the entity of Project Z deck, but cannot confidently determine which Project Z deck the user intends to share. Accordingly, in FIG. 10K, entity resolution module 902 causes device 1000 to display graphical response 1050 that includes candidates 1052 for the Project Z deck. In FIG. 10K, device 100 further receives touch input 1054 that selects candidate 1052(1) for the Project Z deck.

In FIG. 10L, in response to receiving touch input 1054, device 1000 displays graphical response 1060. Graphical response 1060 includes candidate applications 1062 using which candidate 1052(1) for the Project Z deck can be shared. Device 1000 displays graphical response 1060 because the digital assistant cannot confidently determine which application should be used to share candidate 1052(1) for the Project Z deck. In FIG. 10L, device 1000 further receives touch input 1064 that selects candidate application 1062(1).

In response to touch input 1064, type conversion module 904 determines that selected candidate 1052(1) for the Project Z deck has a data type that selected candidate application 1062(1) does not accept (e.g., because another application provided candidate 1052(1) in an incompatible data type). Accordingly, type conversion module 904 converts candidate 1052(1) into a data type compatible with candidate application 1062(1), e.g., based on information, from the application that provided candidate 1052(1), that candidate 1052(1) can be expressed as a data type compatible with candidate application 1062(1). After conversion, type conversion module 904 provides candidate 1052(1) to response management module 906 to complete the task. For example, in FIG. 10M, device 1000 displays user interface 1066 for selected candidate application 1062(1). User interface 1066 shows a newly composed message with selected candidate 1052(1) as an attachment.

Notably, in FIGS. 10K-10L, type conversion module 904 does not convert the data type of all candidates 1052. Rather, type conversion module 904 converts the data type of selected candidate 1052(1) into a data type accepted by selected candidate application 1062(1) based on receiving user selections 1054 and 1064. In this manner, type conversion module 904 conserves processing resources by not converting the data types of undesired candidates and by not converting the data types to be accepted by undesired applications.

FIGS. 11A-11I illustrate various user interactions with a digital assistant that operates on device 1000, according to various examples. To describe various examples herein, FIGS. 11A-11I are discussed in conjunction with response management module 906 of FIG. 9.

In FIG. 11A, while displaying maps application user interface 1104, device 1000 receives speech input 1102 “Siri, show me nearby coffee.” Device 1000 determines, based on speech input 1102, the user intent of searching for nearby coffee.

In some examples, an application (e.g., one or more of applications 914₁-914_{N}) is associated with a predetermined set of intents, referred to herein as “in-application intents” associated with the application. For example, the in-application intents for a maps application (e.g., a navigation application) include: searching for locations, navigating to a user requested location, and inserting text into a search field, the set of in-application intents for a text editing application include: performing text editing operations (e.g., insertion, deletion, and the like), inserting photos, and navigating within the application (e.g., scrolling down and navigating to another section/tab of the application), and the in-application intents for a photos application include: searching for photos, navigating within the application (e.g., scrolling and changing tabs/sections of the application), generating a new photo album, and selecting favorite photos. In-application intents associated with an application can include intents specific to the application (e.g., meaning that only the application can perform the required task(s) to satisfy the intent and/or that the task flow for the intent is specifically configured for the application) and system-level intents that are not specific to the application (e.g., meaning that multiple applications can perform the required task(s) to satisfy the intents). For example, the intent of editing photos is specific to a photo editing application, while the intent of inserting text is shared among multiple applications capable of inserting text (e.g., a messaging application, a note taking application, a web browsing application, and a text editing application).

Response management module 906 (FIG. 9) is configured to conditionally cause device 1000 to display a digital assistant's response within a user interface for an application (referred to herein as an “in-application response”). The in-application response is based on the user intent and is displayed without displaying any portion of the in-application response outside of the user interface. In some examples, if device 1000 displays a user interface for an application while receiving a natural language input and if the user intent corresponds to at least one of the in-application intents associated with the application, device 1000 displays an in-application response. For example, in FIG. 11B, the user intent of searching for nearby coffee matches an in-application intent for the maps application (e.g., searching for locations). Accordingly, device 1000 displays the in-application response in maps application user interface 1104 by displaying pins 1106(1), 1106(2), and 1106(3) to indicate nearby coffee locations.

In some examples, if device 1000 displays a user interface for an application while receiving a natural language input and if the user intent does not correspond to any of the in-application intents associated with the application, device 1000 forgoes displaying an in-application response. Instead, device 1000 displays a response outside of (e.g., above, below, and/or adjacent to) the user interface. For example, in FIG. 11C, while displaying maps application user interface 1104, device 1000 receives speech input 1108 “Siri, what's the score of the 49ers game?”. Because the user intent for speech input 1108 (e.g., searching for sports scores) does not match an in-application intent for the maps application, in FIG. 11D, in response to speech input 1108, device 1000 displays graphical response 1110 on top of maps application user interface 1104.

In some examples, the user intent corresponds to at least one of the in-application intents associated with a respective application, but the user interface displayed when device 1000 receives the natural language input is not for the respective application. In such examples, device 1000 forgoes displaying an in-application response. Instead, device 1000 displays a response outside of the user interface. For example, in FIG. 11E, while displaying home screen user interface 1122, device 1000 receives speech input 1120 “Siri, show me nearby coffee.” The user intent of searching for nearby coffee matches at least one in-application intent for the maps application, but device 1000 displays home screen user interface 1122 instead of maps application user interface 1104. Accordingly, in FIG. 11F, in response to speech input 1120, device 1000 displays graphical response 1124 on top of home screen user interface 1122.

In some examples, if the user intent corresponds to at least one of the in-application intents associated with a respective application and the user interface displayed when device 1000 receives the natural language input is not for the respective application, device 1000 displays (e.g., opens, launches, expands, and/or brings to the foreground) the user interface for the respective application. In some examples, displaying the user interface for the respective application includes opening (e.g., launching) the respective application. Device 1000 further displays the in-application response in the user interface for the respective application. For example, as an alternative to the example of FIGS. 11E-11F, in FIG. 11E, while displaying home screen user interface 1122, device 1000 receives speech input 1120 “Siri, show me nearby coffee.” The user intent of searching for nearby coffee matches at least one in-application intent for the maps application, but device 1000 displays home screen user interface 1122 instead of maps application user interface 1104. In response to receiving speech input 1120, FIG. 11E proceeds to FIG. 11B, in which device 1000 replaces home screen user interface 1122 with maps application user interface 1104. Maps application user interface 1104 includes indications 1106(1)-1106(3) of nearby coffee places.

In some examples, device 1000 receives a natural language input while displaying a current user interface. In response to receiving the natural language input, if the user intent corresponds to at least one of the in-application intents associated with a respective application, device 1000 conditionally displays an in-application response based on a type of the current user interface. For example, if the current user interface is a home screen user interface (or another user interface not specific to one particular application), device 1000 displays an in-application response. As a specific example, in FIG. 11E, because the current user interface is home screen user interface 1122, in response to receiving speech input 1120, in FIG. 11B, device 1000 displays an in-application response in maps user interface 1104. But if the current user interface is a user interface specific to a particular application and if the user intent does not correspond to an in-application intent for the particular application, device 1000 forgoes displaying an in-application response. For example, in FIG. 11C, because the current user interface is maps application user interface 1104 and because the user intent matches an in-application intent for the sports application (not the maps application), in response to receiving speech input 1108, in FIG. 11D, device 1000 displays graphical response 1110 outside of maps application user interface 1104, e.g., to not disrupt the user's experience with maps application user interface 1104.

In some examples, if a user intent does not correspond to an in-application intent for any application, device 1000 forgoes displaying an in-application response. For example, for the natural language input “what are Duraid's favorite coffee shops?”, the user intent of providing a person's favorite locations does not correspond to any in-application intent. Thus, in response to receiving the natural language input, device 1000 displays a graphical response similar to graphical response 1124 in FIG. 11F (e.g., a graphical response that is displayed outside a current user interface and that indicates Duraid's favorite coffee shops).

In some examples, response management module 906 causes device 1000 to display a particular type of animation if the task to be performed satisfies one or more criteria. For example, device 1000 displays the particular type of animation if initiating the task requires replacing a user interface for an application with a different user interface for the application and/or if a user cannot perform the task via the currently displayed user interface for the application.

In FIG. 11G, device 1000 displays library user interface 1132 for a photo application. Device 1000 displays library user interface 1132 because library tab 1140 of the photos application is selected. While displaying library user interface 1132, device 1000 receives speech input 1130 “Siri, show photos from San Francisco.” The user cannot perform the task of searching for photos from San Francisco via library user interface 1132 (e.g., cannot manually perform the task and/or cannot perform the task without requesting the digital assistant to perform the task) because the search function is not available via library user interface 1132. Specifically, to perform the task, the user must select search tab 1142 to navigate from current library user interface 1132 to search user interface 1136 for the photo application (FIG. 11I). Accordingly, in FIGS. 11H-11I, as part of automatically performing the task in response to speech input 1130, device 1000 displays animation 1134 that shows library user interface 1132 changing to search user interface 1136. Animation 1134 includes blurring and/or fading out library user interface 1132 and concurrently fading in search user interface 1136, e.g., by making search user interface 1136 progressively clearer and/or brighter. In FIG. 11I, device 1000 completes animation 1134 and completes the requested task by displaying search user interface 1136 that includes search results for photos from San Fransico.

Displaying animation 1134 when the task satisfies certain criteria provides the user with improved feedback to indicate that device 1000 is navigating between different user interfaces (e.g., different tabs or different menus) for an application. Such improved feedback helps inform the user that device 1000 has successfully interpreted their request and that device 1000 is not performing an undesired operation. In this manner, the user-device interface is made more informative and intuitive, which reduces power usage and improves battery life of device 1000 by enabling the user to use device 1000 more quickly and efficiently.

FIGS. 11J-11P illustrate user interfaces associated with insertion of text, according to various examples.

In FIG. 11J, device 1000 displays text 1150 in email user interface 1174. Device 1000 further receives a user input that selects text 1150. In response to receiving the user input, device 1000 displays indication 1190 that text 1150 is selected.

In FIG. 11K, further in response to receiving the user input that selects text 1150, device 1000 displays text editing user interface 1152. Text editing user interface 1152 includes rewrite option 1154. A selection of rewrite option 1154 causes device 1000 to rewrite selected text 1150. In FIG. 11K, device 1000 receives touch input 1155 that selects rewrite option 1154.

In FIGS. 11L1-11L8 and 11M, in response to receiving touch input 1155, device 1000 generates rewrite 1160 of text 1150 and inserts rewrite 1160 into email user interface 1174. Device 1000 inserts rewrite 1160 via display of animation 1158 in email user interface 1174. Animation 1158 is now discussed with respect to FIGS. 11L1-11L8.

In FIG. 11L1, legend 1156 indicates different colors of text for animation 1158. Legend 1156 is for illustrative purposes only and device 1000 does not display legend 1156 during display of animation 1158. FIGS. 11L1-11L8 illustrate rewrite 1160 over a gray background to emphasize how the visual parameters (e.g., color) of respective portions of rewrite 1160 change as animation 1158 progresses. In some examples, device 1000 does not display the gray background during display of animation 1158.

In FIG. 11L1, time T1 represents a start time of animation 1158. At time T1, portions 1162, 1164, 1166, 1168, 1170, and 1172 of rewrite 1160 are each white in color. At time T1, although portions 1162-1172 are displayed, it may be difficult to view and/or otherwise discern rewrite 1160 if portions 1162-1172 are displayed over a white background. Further, the horizontal dashed lines in FIGS. 11L1-11L8 are illustrated only to delineate portions 1162-1172 and are not displayed during display of animation 1158.

In FIG. 11L2, at time T2 after time T1, portion 1162 changes to be yellow in color and portions 1164-1172 remain white in color. In FIGS. 11L3-11L8, the respective colors of portions 1162-1172 change as illustrated, where time T3 of FIG. 11L3 is after time T2 of FIG. 11L2, time T4 of FIG. 11L4 is after time T3 of FIG. 11L3, and so on. Notably, the color of a respective portion of rewrite 1160 (e.g., portion 1162) is initially white at the start time T1 of animation 1158, and gradually changes to be black as animation 1158 progresses. When the color of a respective portion turns black (e.g., is set to an end color), the color of the respective portion no longer changes as animation 1158 progresses, thereby indicating that insertion of the respective portion is complete. Animation 1158 completes when each of portions 1162-1172 of rewrite 1160 turn black, as shown in FIG. 11L8. As further illustrated in FIGS. 11L1-11L8, animation 1158 appears to move though rewrite 1160 from top to bottom.

The intermediate steps of animation 1158 between times T7 of FIG. 11L7 and T8 of FIG. 11L8 are not shown for brevity but are consistent with the above steps of animation 1158 illustrated by FIGS. 11L1-11L7. Specifically, during the intermediate steps:
at time T7.1 after time T7, the color of portion 1168 changes to black, the color of portion 1170 changes to purple, the color of portion 1172 changes to red, and the colors of portions 1162-1166 remain black;
at time T7.2 after time T7.1, the color of portion 1170 changes to black, the color of portion 1172 changes to purple, and the colors of portions 1162-1168 remain black; and
at time T7.3 after time T7.2, the color of portion 1172 changes to black and the colors of portions 1162-1170 remain black.

In FIG. 11L8, time T8 (which is after time T7.3) represents the end time of animation 1158, as all portions of rewrite 1160 have turned black. In FIG. 11M, animation 1158 has completed and device 1000 has completed insertion of rewrite 1160 into email user interface 1174.

In FIG. 11N, while displaying note taking application user interface 1176, device 1000 receives speech input 1178 “Siri, add Marissa's number.” In FIGS. 11O1-11O2 and 11P, in response to receiving speech input 1178, device 1000 performs the task of determining phone number 1183 of a contact named “Marissa” and inserting phone number 1183 into note taking application user interface 1176. Device 1000 inserts phone number 1183 via display of animation 1182 in FIGS. 11O1-11O2.

Legend 1180 in FIG. 11O1 indicates different colors of text for animation 1182. Like legend 1156, legend 1180 is for illustrative purposes only and device 1000 does not display legend 1156 during display of animation 1182. FIGS. 11O1-11O2 illustrate phone number 1183 over a gray background to emphasize how the visual parameters (e.g., color) of respective portions of phone number 1183 change as animation 1182 progresses. In some examples, device 1000 does not display the gray background during display of animation 1182.

In FIGS. 11O1-11O2, device 1000 gradually inserts portions 1184-1188 of phone number 1183, via animation 1182, in the manner described below. The vertical dashed lines in FIGS. 11O1-11O2 are illustrated only to delineate portions 1184-1188 and are not displayed during display of animation 1182. In FIG. 11O1, at time T1, device 1000 displays (e.g., inserts) portion 1184 in white. At time T2 after time T1, device 1000 displays (e.g., inserts) portion 1185 in white and changes the color of portion 1184 from white to yellow. At time T3 after time T2, device 1000 displays (e.g., inserts) portion 1186 in white, changes the color of portion 1185 to yellow, and changes the color of portion 1184 to red. At time T4 after time T3, device 1000 displays (e.g., inserts) portion 1187 in white, changes the color of portion 1186 from white to yellow, changes the color of portion 1185 from yellow to red, and changes the color of portion 1184 from red to purple. Animation 1182 then progresses through times T5, T6, T7, and T8 (as illustrated) until completion at time T9. As illustrated, when the color of a respective portion of phone number 1183 turns black (e.g., reaches an end color), the respective portion no longer changes in color, thereby indicating that insertion of the respective portion is complete. As further illustrated, animation 1182 appears to move through phone number 1183 from left to right.

As further illustrated in FIGS. 11O1-11O2, the height of phone number 1183 increases and decreases as animation 1182 progresses. Specifically, as illustrated, the height of phone number 1183 (e.g., the height of the inserted portions of phone number 1183) has an initial height at time T1, gradually increases to a maximum height at time T5, and then gradually decreases back to the initial height at time T8, e.g., when animation 1182 ends.

In FIG. 11P, animation 1182 has completed and device 1000 has completed insertion of phone number 1183 into note taking application user interface 1176.

### 5. Processes for Operating a Digital Assistant

FIG. 12 illustrates process 1200 for operating a digital assistant, according to various examples. Process 1200 is performed, for example, using one or more electronic devices implementing a digital assistant. In some examples, process 1200 is performed using a client-server system (e.g., system 100), and the blocks of process 1200 are divided up in any manner between the server (e.g., DA server 106) and a client device. In other examples, the blocks of process 1200 are divided up between the server and multiple client devices (e.g., a mobile phone and a smart watch). Thus, while portions of process 1200 are described herein as being performed by particular devices of a client-server system, it will be appreciated that process 1200 is not so limited. In other examples, process 1200 is performed using only a client device (e.g., user device 104) or only multiple client devices. In process 1200, some blocks are, optionally, combined, the order of some blocks is, optionally, changed, and some blocks are, optionally, omitted. In some examples, additional steps may be performed in combination with the process 1200.

Process 1200 includes receiving (1202) a first natural language input (e.g., speech input and/or text input) (e.g., 1002, 1010, 1012, and/or 1020) that corresponds to a request to perform a first task with a first application (e.g., a software application) (e.g., at least one of applications 914₁-914_{N}), wherein the first natural language input specifies an entity (e.g., a parameter for the task that is different from the first application) for the first task (e.g., one or more of the entities discussed with respect to FIGS. 10A-10F).

Process 1200 includes in response to (1204) receiving the first natural language input and after the entity is determined (e.g., disambiguated and/or resolved) (e.g., after a specific value is determined for the entity) (e.g., determined by entity resolution module 902): in accordance with a determination (e.g., by type conversion module 904) that (1206) a set of criteria is satisfied, wherein the set of criteria includes a first criterion that is satisfied when a data type (e.g., a file type) for the determined entity does not match (e.g., is incompatible with) a data type (e.g., a file type) accepted by the first application: causing (1208) (e.g., by type conversion module 904) the data type for the determined entity to be modified (e.g., converted and/or transformed) to match (e.g., to be compatible with and/or to be the same as) the data type accepted by the first application to obtain a compatible data type for the determined entity (e.g., 910); and initiating (1210) the first task based on the compatible data type for the determined entity (e.g., at least one of the tasks described with respect to FIGS. 10A-10F).

In some examples, process 1200 includes: in response to receiving the first natural language input and after the entity is determined: in accordance with a determination that the set of criteria is not satisfied: forgoing (e.g., by type conversion module 904) causing the data type for the determined entity to be modified to match the data type accepted by the first application; and initiating the first task based on the data type for the determined entity (e.g., the unmodified data type for the determined entity) (e.g., as described with respect to FIGS. 10E-10F). In some examples, the set of criteria is not satisfied when the data type for the determined entity matches a data type accepted by the first application. In some examples, the set of criteria is not satisfied when the application that provides the determined entity (e.g., the application that the determined entity comes from, the application that stores the determined entity, and/or the application that the entity is stored in association with) (e.g., at least one of applications 914₁-914_{N}) is the same as the first application.

In some examples, the determined entity is provided by a second application (e.g., the application that the determined entity comes from, the application that stores the determined entity, and/or the application that the entity is stored in association with) (e.g., at least one of applications 914₁-914_{N}) different from the first application.

In some examples, process 1200 includes: displaying a user interface for the first application (e.g., 1004, 1008, and/or 1022), wherein the first natural language input is received while the user interface is displayed, and wherein initiating the first task based on the compatible data type for the determined entity includes modifying the user interface (e.g., adding content to the user interface, removing content from the user interface, navigating within the user interface, navigating from the user interface to another user interface for the first application, and/or otherwise modifying the user interface to indicate performance of the task) (e.g., as described with respect to FIGS. 10A-10F).

In some examples, the entity corresponds to contact information (e.g., a phone number, an email address, a username, a user identifier, and/or physical address), to a location, and/or to a media item (e.g., an image, an audio file, and/or a video file).

In some examples, a third application (e.g., software application) (e.g., at least one of applications 914₁-914_{N}) provides, to a first entity database (e.g., 912), a first candidate entity and information about a data type (e.g., a file type) that the first candidate entity can be expressed as (e.g., transformed into, converted into, and/or exported as); and a fourth application (e.g., software application) (e.g., at least one of applications 914₁-914_{N}) provides, to the first entity database, a second candidate entity and information about a data type that the second candidate entity can be expressed as, wherein the fourth application is different from the third application.

In some examples, the entity is determined (e.g., by entity resolution module 902) by searching the first entity database.

In some examples, the determined entity is the first candidate entity; the compatible data type for the determined entity is the data type that the first candidate entity can be expressed as; and the set of criteria includes a second criterion that is satisfied when the data type that the first candidate entity can be expressed as matches the data type accepted by the first application.

In some examples, the first candidate entity and the information about the data type that the first candidate entity can be expressed as are provided by the third application before receiving the natural language input; and the second candidate entity and the information about the data type that the second candidate entity can be expressed as are provided by the third application before receiving the natural language input.

In some examples, process 1200 includes: initiating (e.g., by entity resolution module 902) a query to a fifth application (e.g., at least one of applications 914₁-914_{N}), wherein the query requests for one or more entities from the fifth application and information about one or more data types that the one or more entities from the fifth application can be expressed as; and receiving (e.g., by entity resolution module 902 and/or by entity database 912) a response to the query to the fifth application, wherein the response to the query to the fifth application includes the one or more entities from the fifth application and the information about the one or more data types that the one or more entities from the fifth application can be expressed as, wherein the set of criteria includes a third criterion that is satisfied when the response to the query to the fifth application is received (e.g., as described with respect to FIGS. 10C1 and 10D and/or with respect to FIGS. 10C2 and 10D).

In some examples, process 1200 includes: in response to receiving the first natural language input (e.g., 1010): in accordance with a determination that a second entity database (e.g., 912) does not include the entity (e.g., if searching the second entity database for the entity does not yield any matches or, does not yield any matches that have sufficient confidence), initiating (e.g., by entity resolution module 902) a query to a sixth application (e.g., at least one of applications 914₁-914_{N}) for the entity; and receiving (e.g., by entity resolution module 902 and/or by entity database 912) a response to the query to the sixth application, wherein the response to the query to the sixth application includes the entity (e.g., the determined entity) and information about a data type the entity can be expressed as, wherein the set of criteria includes a fourth criterion that is satisfied when the response to the query to the sixth application is received (e.g., as described with respect to FIGS. 10C1 and 10D). In some examples, the sixth application is queried to determine the entity. In some examples, the set of criteria additionally or alternatively includes another criterion that is satisfied when the data type the entity can be expressed as (as indicated by the response to the query) matches the data type accepted by the first application.

In some examples, process 1200 includes: in response to receiving the first natural language input (e.g., 1012): in accordance with a determination that the natural language input specifies a sixth application (e.g., at least one of applications 914₁-914_{N}) for the first task, initiating (e.g., by entity resolution module 902) a query to the sixth application for the entity; and receiving (e.g., by entity resolution module 902 and/or by entity database 912) a response to the query to the sixth application, wherein the response to the query to the sixth application includes the entity (e.g., the determined entity) and information about a data type the entity can be expressed as, wherein the set of criteria includes a fourth criterion that is satisfied when the response to the query to the sixth application is received (e.g., as described with respect to FIGS. 10C2 and 10D). In some examples, the sixth application is queried to determine the entity. In some examples, the set of criteria additionally or alternatively include another criterion that is satisfied when the data type the entity can be expressed as (as indicated by the response to the query) matches the data type accepted by the first application.

In some examples, the first application defines one or more data types accepted by the first application.

In some examples, the data type accepted by the first application is determined (e.g., by type conversion module 904) based on the first natural language input. In some examples, the data type accepted by the first application is determined by determining, based on the first natural language input, a type (e.g., phone number, email, location, image, and/or video) for the entity and selecting, from a plurality of data types accepted by the application (e.g., string, GPS coordinates, .jpeg, .png, .mov, .mp4, and the like) the accepted data types that match the entity type.

In some examples, process 1200 includes: receiving a second natural language input (e.g., 1032) that corresponds to a request to perform a second task with a seventh application (e.g., at least one of applications 914₁-914_{N}), wherein the second natural language input specifies a second entity for the second task (e.g., as described with respect to FIG. 10G).

In some examples, process 1200 includes: in response to receiving the second natural language input, displaying a selectable option for the second entity (e.g., 1034, 1036, and/or 1036(1)). In some examples, process 1200 includes displaying a list of multiple different options for the second entity (e.g., 1036), wherein the option is included in the list of multiple different options. In some examples, the multiple different options correspond to respective different interpretations (e.g., possible disambiguation options) for the second entity. In some examples, process 1200 includes displaying the selectable option and/or the list of multiple different options in accordance with a determination that the entity is ambiguous and/or that the device cannot disambiguate the entity.

In some examples, process 1200 includes receiving a user input (e.g., touch input, speech input, gesture input, peripheral device input, and/or gaze input) (e.g., 1038) corresponding to a selection of the selectable option for the second entity. In some examples, the device determines the second entity based on the user input.

In some examples, process 1200 includes: in response to receiving the user input corresponding to the selection of the selectable option for the second entity: in accordance with a determination (e.g., by type conversion module 904) that a data type for the second entity does not match a data type accepted by the seventh application (in some examples, instead, in accordance with a determination that a set of criteria is satisfied, wherein the set of criteria includes criterion analogous to the criteria discussed above): causing (e.g., by type conversion module 904) the data type for the second entity to be modified to match the data type accepted by the seventh application to obtain a compatible data type for the second entity; and initiating the second task based on the compatible data type for the second entity (e.g., as described with respect to FIGS. 10H-10I). In some examples, the data type for the second entity is not modified before receiving the user input. In some examples, process 1200 includes: in response to receiving the user input and in accordance with a determination that a data type for the second entity matches the data type accepted by the seventh application, forgoing (e.g., by type conversion module 904) causing the data type for the second entity to be modified and initiating the second task based on the data type for the second entity. In some examples, process 1200 includes: in response to receiving the user input and in accordance with a determination that the set of criteria is not satisfied, forgoing (e.g., by type conversion module 904) causing the data type for the second entity to be modified and initiating the second task based on the data type for the second entity.

In some examples, process 1200 includes: receiving a third natural language input (e.g., 1041) that corresponds to a request to perform a third task, wherein the third natural language input specifies a third entity for the third task (e.g., as described with respect to FIG. 10J).

In some examples, process 1200 includes: after receiving the third natural language input (e.g., in response to receiving the third natural language input and/or after receiving at least a portion of the third natural language input), displaying a selectable option for a candidate application for the third task (e.g., 1060, 1062, and/or 1062(1)). In some examples process 1200 includes: displaying a list of selectable options (e.g., 1060 and/or 1062) for different respective applications for the third task, wherein the list of selectable options includes the selectable options. In some examples, the list of selectable options corresponds to respective different applications for the task. In some examples, the selectable option or the list of selectable options are displayed after the entity is determined (e.g., as illustrated in FIGS. 10K-10L).

In some examples, process 1200 includes: receiving a user input (e.g., 1064) (e.g., touch input, speech input, gesture input, peripheral device input, and/or gaze input) corresponding to a selection of the selectable option for the candidate application.

In some examples, process 1200 includes: in response to receiving the user input corresponding to the selection of the selectable option for the candidate application (and, in some examples, after the third entity is determined): in accordance with a determination (e.g., by type conversion module 904) that a data type for the third entity does not match a data type accepted by the candidate application (in some examples, instead, in accordance with a determination that a set of criteria is satisfied, wherein the set of criteria includes criterion analogous to the criteria discussed above): causing (e.g., by type conversion module 904) the data type for the third entity to be modified to match the data type accepted by the candidate application to obtain a compatible data type for the third entity; and initiating the third task based on the compatible data type for the third entity (e.g., as discussed above with respect to FIGS. 10L-10M). In some examples, the data type for the third entity is not modified before receiving the user input. In some examples, process 1200 includes: in response to receiving the user input, and in accordance with a determination that a data type for the third entity matches the data type accepted by the candidate application, forgoing (e.g., by type conversion module 904) causing the data type for the third entity to be modified and initiating the third task based on the data type for the third entity. In some examples, process 1200 includes: in response to receiving the user input, and in accordance with a determination that the set of criteria is not satisfied, forgoing (e.g., by type conversion module 904) causing the data type for the third entity to be modified and initiating the third task based on the data type for the third entity.

The operations described above with reference to FIG. 12 are optionally implemented by components depicted in FIGS. 1-4G, 6A-6B, 7A-7C, 8, and 9. For example, the operations of process 1200 may be implemented by digital assistant system 700 operating in conjunction with system 900. It would be clear to a person having ordinary skill in the art how other processes are implemented based on the components depicted in FIGS. 1-4G, 6A-6B, 7A-7C, and 8.

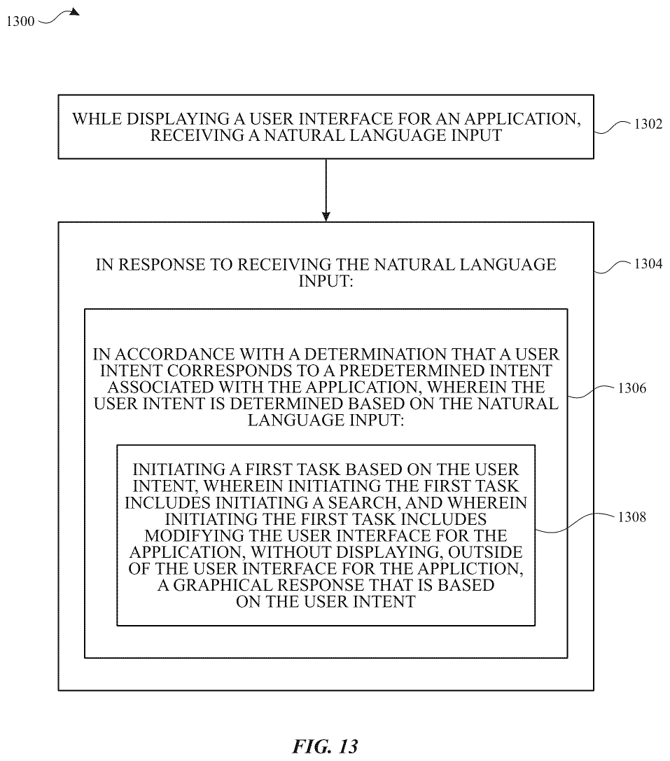

FIG. 13 illustrates process 1300 for operating a digital assistant, according to various examples. Process 1300 is performed, for example, using one or more electronic devices implementing a digital assistant. In some examples, process 1300 is performed using a client-server system (e.g., system 100), and the blocks of process 1300 are divided up in any manner between the server (e.g., DA server 106) and a client device. In other examples, the blocks of process 1300 are divided up between the server and multiple client devices (e.g., a mobile phone and a smart watch). Thus, while portions of process 1300 are described herein as being performed by particular devices of a client-server system, it will be appreciated that process 1300 is not so limited. In other examples, process 1300 is performed using only a client device (e.g., user device 104) or only multiple client devices. In process 1300, some blocks are, optionally, combined, the order of some blocks is, optionally, changed, and some blocks are, optionally, omitted. In some examples, additional steps may be performed in combination with the process 1300.

Process 1300 includes: while displaying a user interface for an application (e.g., 1104, 1132, 1004, 1008, and/or 1022) (e.g., a software application), receiving (1302) a natural language input (e.g., 1102, 1108, 1130, 1002, 1010, 1012, and/or 1020) (e.g., speech input and/or text input).

Process 1300 includes: in response to (1304) receiving the natural language input: in accordance with a determination that (1306) a user intent corresponds to (e.g., matches and/or corresponds to a same type of task as) a predetermined intent associated with the application (e.g., that the user intent corresponds to at least one intent of a predetermined set of intents associated with the application), wherein the user intent is determined based on the natural language input (and optionally in accordance with a determination that a digital assistant session is initiated): initiating (1308) a first task based on the user intent, wherein initiating the first task includes initiating a search (e.g., for data within the application and/or for data from another application), and wherein initiating the first task includes modifying the user interface for the application, without displaying, outside of the user interface for the application (e.g., outside of any user interface for the application), a (e.g., any) graphical response that is based on the user intent (e.g., without displaying any portion of the graphical response outside (e.g., over, under, or adjacent to) the user interface for the application, e.g., such that the graphical response is entirely contained within the user interface for the application) (e.g., as illustrated by FIGS. 11A-11B, 11G-11I, 10A-10B, 10C1-10D, 10C2-10D, and 10E-10F). In some examples, modifying the user interface for the application includes displaying a graphical response that is based on the user intent, where the graphical response is contained within (e.g., entirely contained within) and/or inside (e.g., entirely inside) the user interface for the application (e.g., any user interface for the application). In some examples, initiating the search includes initiating a search for data local to the user device and/or data stored in association with the user and/or the user's account, e.g., data that requires the user to be authenticated for access to the data. In some examples, initiating the search includes searching external sources (e.g., the internet).

In some examples, the predetermined intent associated with the application corresponds to a predetermined type of action a digital assistant can cause the application to perform. In some examples, an application is associated with a predetermined set of intents, where each intent of the predetermined set of intents corresponds to a different action a digital assistant can cause the application to perform.

In some examples, process 1300 includes: in response to receiving the natural language input: in accordance with a determination that the user intent does not correspond to a predetermined intent associated with the first application (e.g., that the user intent does not correspond to any intent of the predetermined set of intents associated with the application): initiating a second task based on the user intent, wherein initiating the second task includes displaying, outside of the user interface for the application, a second graphical response that is based on the user intent (e.g., displaying the second graphical response at least partially over, under, and/or adjacent to the user interface for the application, such that at least a portion of the second graphical response is outside of the user interface for the application) (e.g., as illustrated by FIGS. 11C-11D).

In some examples, process 1300 includes: while displaying a current user interface (e.g., 1122), receiving a second natural language input (e.g., 1120) that corresponds to (e.g., requests for) the same first task; and in response to receiving the second natural language input: in accordance with a determination that the current user interface is not the user interface for the application (e.g., is not user interface 1104) (e.g., is not any user interface for the application): initiating the first task, wherein initiating the first task includes displaying, outside of the current user interface, a third graphical response (e.g., 1124) (e.g., as illustrated by FIGS. 11E-11F). In some examples, process 1300 includes: in response to receiving the second natural language input and in accordance with a determination that the current user interface is a/the user interface for the application, initiating the first task, wherein initiating the first task includes modifying the user interface for the application, without displaying, outside of the user interface for the application, any graphical response that is based on the user intent.

In some examples, modifying the user interface for the application includes modifying the user interface for the application to indicate results of the search (e.g., to indicate results of a search for messages, to indicate results of a search for media content, to indicate results of a search for notes, to indicate results of a search for photos, or the like) (e.g., as illustrated by FIGS. 11A-11B, 11G-11I, 10A-10B, 10C1-10D, 10C2-10D, and 10E-10F).

In some examples, the user interface for the application includes a map user interface (e.g., 1104) and wherein modifying the user interface for the application to indicate the results of the search includes indicating (e.g., via 1106(1)-1106(3)) one or more locations on the map user interface (e.g., as pins on the map).

In some examples, initiating the first task includes navigating (e.g., scrolling, changing to a next section, changing to a previous section, and/or replacing the user interface for the application with another user interface for the application) with respect to the user interface for the application (e.g., as illustrated by FIGS. 11G-11I).

In some examples, initiating the first task includes performing a text editing operation (e.g., adding content, deleting content, changing a property (e.g., color, font size, and the like) of the content, and/or selecting content) and wherein modifying the user interface for the application includes indicating a result of the text editing operation (e.g., as illustrated by FIGS. 10C1-10D and 10C2-10D).

In some examples, modifying the user interface for the application includes: in accordance with a determination that the first task satisfies a set of criteria: displaying a first type of animation (e.g., 1134) (e.g., an animation that includes pulsing and/or blurring the current user interface); and in accordance with a determination that the first task does not satisfy the set of criteria: modifying the user interface for the application without displaying the first type of animation. In some examples, the first type of animation transitions the user interface for the application to a different user interface for the application.

In some examples, the set of criteria includes a first criterion that is satisfied when initiating the first task includes replacing the user interface for the application (e.g., 1132) with a different second user interface for the application (e.g., 1136) (e.g., switching between sections, pages, menus, and/or tabs of the application).

In some examples, the set of criteria include a second criterion that is satisfied when a user of the electronic device cannot perform the first task via the user interface for the application (e.g., 1132) (e.g., cannot manually perform the task, e.g., cannot perform the task without requesting the digital assistant to perform the task). In some examples, the user instead navigates to a different user interface for the application (e.g., 1136) to be able to perform the task, e.g., because the user interface for the application does not include the correct controls to perform the task.

In some examples, the user interface for the application (e.g., 1132) does not include one or more controls (e.g., one or more graphical elements selectable to cause the application to perform respective operations) to perform the first task; a different user interface for the application (e.g., 1136) includes the one or more controls to perform the first task; and the user cannot perform the first task via the user interface for the application because the user interface for the application does not include the one or more controls to perform the first task. In some examples, the set of criteria includes a third criterion that is satisfied when the user interface for the application does not include one or more controls to perform the first task and when a different user interface for the application includes the one or more controls to perform the first task.

In some examples, process 1300 includes: while displaying a respective user interface (e.g., 1174 or 1176), receiving a user input (e.g., 1155 or 1178) corresponding to a request to insert content (e.g., 1160 or 1183) (e.g., text, a photo, a video, and/or another graphical element) (e.g., to add content and/or to replace previously entered content with new content) and in response to receiving the user input: in accordance with a determination that the user input satisfies a set of input criteria: inserting the content into the respective user interface, including displaying an animation (e.g., 1158 or 1182) that moves through the content in a first direction (e.g., left to right, right to left, up to down, or down to up), wherein the content includes a first portion (e.g., 1162, 1164, 1166, 1168, 1184, 1185, or 1186), a second portion (e.g., 1164, 1166, 1168, 1170, 1185, 1186, or 1187) that follows, relative to the first direction, the first portion, and a third portion (e.g., 1166, 1168, 1170, 1172, 1186, 1187, or 1188), that follows, relative to the first direction, the second portion. In some examples, the second portion is consecutive to the first portion in the first direction, meaning that there is no portion of the content in between the first portion and the second portion and/or the first portion directly contacts the second portion. In some examples, the third portion is consecutive to the second portion in the first direction, meaning that there is no portion of the content in between the second portion and the third portion and/or the second portion directly contacts the third portion.

Displaying the animation includes: at a first time (e.g., times T1, T2, T3, T4, T5, T6, or T7 in FIGS. 11L1-11L8 or times T1, T2, T3, T4, T5, T6, or T7 in FIGS. 11O1-11O2): displaying the first portion such that a first visual parameter (e.g., color, brightness, opacity, or size) of the first portion has a first value (e.g., first color, first brightness, first opacity, or first size); at a second time (e.g., times T2, T3, T4, T5, T6, or T7 in FIGS. 11L1-11L8 or times T2, T3, T4, T5, T6, T7, or T8 in FIGS. 11O1-11O2) after the first time: displaying the first portion such that the first visual parameter of the first portion has a second value different from the first value; and displaying the second portion such that a second visual parameter of the second portion has the first value; and at a third time (e.g., times T3, T4, T5, T6, T7, or T8 in FIGS. 11L1-11L8 or times T3, T4, T5, T6, T7, T8, or T9 in FIGS. 11O1-11O2) after the second time: displaying the first portion such that the first visual parameter of the first portion has a third value different from the first value and the second value; displaying the second portion such that the second visual parameter of the second portion has the second value; and displaying the third portion such that a third visual parameter of the third portion has the first value, wherein the first visual parameter, the second visual parameter, and the third visual parameter are the same type of visual parameter (e.g., color, brightness, opacity, or size).

In some examples, process 1300 includes in response to receiving the user input, in accordance with a determination that the user input does not satisfy the set of input criteria, forgoing displaying the animation. In some examples, the animation completes when the respective visual parameters of all portions of the content each have the same value, e.g., an end value. In some examples, the insertion of the content completes when the animation completes. In some examples, the first visual parameter of the first portion has the first value when the animation begins and the first visual parameter of the first portion gradually changes to have an end value as the animation progresses. When a visual parameter of a respective portion has the end value, the visual parameter of the respective portion no longer changes as the animation progresses. In some examples, the animation completes when the respective visual parameters of each portion of the content each have the end value, as described and illustrated herein.

In some examples, the set of input criteria includes a first input criterion that is satisfied when the user input (e.g., 1178) corresponds to a request for a digital assistant to insert the content (e.g., when the user input includes a natural language request for the digital assistant to insert the content). In some examples, the set of input criteria includes a second input criterion that is satisfied when the user input (e.g., 1155) corresponds to a request to automatically rewrite a selected portion of respective content. In some examples, the content is generated using generative artificial intelligence.

In some examples, displaying the animation includes: moving the content in a second direction (e.g., upwards) (e.g., moving the entire content and/or moving the content that has currently been inserted); and after moving the content in the second direction, moving the content in a third direction that is opposite to the second direction (e.g., moving the entire content and/or moving the content that has currently been inserted) (e.g., as illustrated in FIGS. 11O1-11O2). In some examples, the content moves in the second direction while the content is being inserted and the content moves in the third direction to indicate that the insertion of the content is complete.

In some examples, in accordance with a determination that the content has a first size (e.g., area, volume, length, or word count), the animation has a first speed (e.g., that defines how quickly the animation completes); and in accordance with a determination that the content has a second size that is larger than the first size, the animation has a second speed that is greater than the first speed. In some examples, the speed of the animation depends on the size of the content being inserted, such that all insertions of content via the animation appear to complete within the same time, regardless of the size of the content being inserted.

Conditionally displaying the animation (e.g., 1158 or 1182) as described herein provides the user with improved feedback that the device is inserting text via a particular type of process (e.g., a digital assistant process and/or a generative artificial intelligence process). Providing improved user feedback makes the user-device interface more efficient (e.g., by informing the user that the device is operating as desired, by preventing user inputs otherwise received if the user believes the device is not operating as desired, and by distinguishing between different types of text insertion methods), which additionally reduces power usage and improves battery life of the device by enabling the user to use the device more quickly and efficiently.

The operations described above with reference to FIG. 13 are optionally implemented by components depicted in FIGS. 1-4G, 6A-6B, 7A-7C, 8, and 9. For example, the operations of process 1300 may be implemented by digital assistant system 700 operating in conjunction with system 900. It would be clear to a person having ordinary skill in the art how other processes are implemented based on the components depicted in FIGS. 1-4G, 6A-6B, 7A-7C, and 8.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the capability of a digital assistant. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to perform requested tasks. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for digital assistant services or anytime thereafter. In another example, users can select not to allow a digital assistant to access personal information data. In yet another example, users can select to limit the length of time for which a digital assistant can access personal information data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a digital assistant can perform tasks based on non-personal information data or a bare minimum amount of personal information, such as the content being requested by the device associated with a user, other non-personal information available to the digital assistant, or publicly available information.

What is claimed is:

1. A non-transitory computer-readable storage medium storing one or more programs, the one or more programs comprising instructions, which when executed by one or more processors of a first electronic device, cause the first electronic device to:
while displaying a user interface for an application, receive a natural language input; and
in response to receiving the natural language input:
in accordance with a determination that a user intent corresponds to a predetermined intent associated with the application, wherein the user intent is determined based on the natural language input:
initiate a first task based on the user intent, wherein initiating the first task includes initiating a search, and wherein initiating the first task includes modifying the user interface for the application, without displaying, outside of the user interface for the application, a graphical response that is based on the user intent.

2. The non-transitory computer-readable storage medium of claim 1, wherein the predetermined intent associated with the application corresponds to a predetermined type of action a digital assistant can cause the application to perform.

3. The non-transitory computer-readable storage medium of claim 1, wherein the one or more programs further comprise instructions, which when executed by the one or more processors of the first electronic device, cause the first electronic device to:
in response to receiving the natural language input:
in accordance with a determination that the user intent does not correspond to a predetermined intent associated with the first application:
initiate a second task based on the user intent, wherein initiating the second task includes displaying, outside of the user interface for the application, a second graphical response that is based on the user intent.

4. The non-transitory computer-readable storage medium of claim 1, wherein the one or more programs further comprise instructions, which when executed by the one or more processors of the first electronic device, cause the first electronic device to:
while displaying a current user interface, receive a second natural language input that corresponds to the same first task; and
in response to receiving the second natural language input:
in accordance with a determination that the current user interface is not the user interface for the application:
initiate the first task, wherein initiating the first task includes displaying, outside of the current user interface, a third graphical response.

5. The non-transitory computer-readable storage medium of claim 1, wherein modifying the user interface for the application includes modifying the user interface for the application to indicate results of the search.

6. The non-transitory computer-readable storage medium of claim 5, wherein the user interface for the application includes a map user interface and wherein modifying the user interface for the application to indicate the results of the search includes indicating one or more locations in the map user interface.

7. The non-transitory computer-readable storage medium of claim 1, wherein initiating the first task includes navigating with respect to the user interface for the application.

8. The non-transitory computer-readable storage medium of claim 1, wherein initiating the first task includes performing a text editing operation and wherein modifying the user interface for the application includes indicating a result of the text editing operation.

9. The non-transitory computer-readable storage medium of claim 1, wherein modifying the user interface for the application includes:
in accordance with a determination that the first task satisfies a set of criteria:
displaying a first type of animation; and
in accordance with a determination that the first task does not satisfy the set of criteria:
modifying the user interface for the application without displaying the first type of animation.

10. The non-transitory computer-readable storage medium of claim 9, wherein the set of criteria include a first criterion that is satisfied when initiating the first task includes replacing the user interface for the application with a different second user interface for the application.

11. The non-transitory computer-readable storage medium of claim 9, wherein the set of criteria include a second criterion that is satisfied when a user of the electronic device cannot perform the first task via the user interface for the application.

12. The non-transitory computer-readable storage medium of claim 11, wherein:
the user interface for the application does not include one or more controls to perform the first task;
a different user interface for the application includes the one or more controls to perform the first task; and
the user cannot perform the first task via the user interface for the application because the user interface for the application does not include the one or more controls to perform the first task.

13. The non-transitory computer-readable storage medium of claim 1, wherein the one or more programs further comprise instructions, which when executed by the one or more processors of the first electronic device, cause the first electronic device to:
while displaying a respective user interface, receive a user input corresponding to a request to insert content; and
in response to receiving the user input:
in accordance with a determination that the user input satisfies a set of input criteria:
insert the content into the respective user interface, including displaying an animation that moves through the content in a first direction, wherein the content includes a first portion, a second portion that follows, relative to the first direction, the first portion, and a third portion, that follows, relative to the first direction, the second portion, and wherein displaying the animation includes:
at a first time:
displaying the first portion such that a first visual parameter of the first portion has a first value;
at a second time after the first time:
displaying the first portion such that the first visual parameter of the first portion has a second value different from the first value; and
displaying the second portion such that a second visual parameter of the second portion has the first value; and
at a third time after the second time:
displaying the first portion such that the first visual parameter of the first portion has a third value different from the first value and the second value;
displaying the second portion such that the second visual parameter of the second portion has the second value; and
displaying the third portion such that a third visual parameter of the third portion has the first value, wherein the first visual parameter, the second visual parameter, and the third visual parameter are the same type of visual parameter.

14. The non-transitory computer-readable storage medium of claim 13, wherein the set of input criteria includes a first input criterion that is satisfied when the user input corresponds to a request for a digital assistant to insert the content.

15. The non-transitory computer-readable storage medium of claim 13, wherein the set of input criteria includes a second input criterion that is satisfied when the user input corresponds to a request to automatically rewrite a selected portion of respective content.

16. The non-transitory computer-readable storage medium of claim 13, wherein displaying the animation includes:
moving the content in a second direction; and
after moving the content in the second direction, moving the content in a third direction that is opposite to the second direction.

17. The non-transitory computer-readable storage medium of claim 13, wherein:
in accordance with a determination that the content has a first size, the animation has a first speed; and
in accordance with a determination that the content has a second size that is larger than the first size, the animation has a second speed that is greater than the first speed.

18. An electronic device, comprising:
one or more processors;
a memory; and
one or more programs, wherein the one or more programs are stored in the memory and configured to be executed by the one or more processors, the one or more programs including instructions for:
while displaying a user interface for an application, receiving a natural language input; and
in response to receiving the natural language input:
in accordance with a determination that a user intent corresponds to a predetermined intent associated with the application, wherein the user intent is determined based on the natural language input:
initiating a first task based on the user intent, wherein initiating the first task includes initiating a search, and wherein initiating the first task includes modifying the user interface for the application, without displaying, outside of the user interface for the application, a graphical response that is based on the user intent.

19. A method, comprising:
at an electronic device with one or more processors and memory:
while displaying a user interface for an application, receiving a natural language input; and
in response to receiving the natural language input:
in accordance with a determination that a user intent corresponds to a predetermined intent associated with the application, wherein the user intent is determined based on the natural language input:
initiating a first task based on the user intent, wherein initiating the first task includes initiating a search, and wherein initiating the first task includes modifying the user interface for the application, without displaying, outside of the user interface for the application, a graphical response that is based on the user intent.
